(19) United States
(12) Patent Application Publication
(10) Pub. No.: US 2024/0188476 A1
(43) Pub. Date: Jun. 13, 2024

(54) MANAGEMENT SYSTEM, AND METHOD FOR MANAGING ACCESS OF AGRICULTURAL MACHINE TO FIELD

(71) Applicant: KUBOTA CORPORATION, Osaka (JP)

(72) Inventors: Yuki KUBOTA, Sakai-shi (JP); Toru TAMBO, Sakai-shi (JP); Itsuki OKUBO, Sakai-shi (JP); Kazuki OTA, Sakai-shi (JP)

(21) Appl. No.: 18/426,131

(22) Filed: Jan. 29, 2024

Related U.S. Application Data
(63) Continuation of application No. PCT/JP2022/013220, filed on Mar. 22, 2022.

(30) Foreign Application Priority Data
Jul. 30, 2021 (JP) 2021-125842

(51) Int. Cl. A01B 69/04; A01B 69/00; A01B 79/00

(52) U.S. Cl. CPC A01B 69/008; A01B 69/001; A01B 79/005

(57) ABSTRACT

A management system manages access of agricultural machines to a field, and includes a processor configured or programmed to, while a first agricultural machine is performing an agricultural task in the field and if a conflict of agricultural tasks for the field exists between the first agricultural machine and a second agricultural machine, allow at least one of the first agricultural machine and the second agricultural machine determined based on priority data to perform the agricultural task for the field.

### CROSS REFERENCE TO RELATED APPLICATIONS

This application claims the benefit of priority to Japanese Patent Application No. 2021-125842 filed on Jul. 30, 2021 and is a Continuation Application of PCT Application No. PCT/JP2022/013220 filed on Mar. 22, 2022. The entire contents of each application are hereby incorporated herein by reference.

### BACKGROUND OF THE INVENTION

### 1. Field of the Invention

The present disclosure relates to management systems for managing access of agricultural machines to fields, and methods for managing access of agricultural machines to fields.

### 2. Description of the Related Art

Research and development has been directed to the automation of work vehicles such as tractors to be used in fields. For example, work vehicles which travel via automatic steering by utilizing a positioning system, e.g., a GNSS (Global Navigation Satellite System) that is capable of precise positioning, have come into practical use. Work vehicles which automatically perform not only automatic steering but also speed control have also come into practical use.

Japanese Laid-Open Patent Publication No. 2016-31649 discloses a work vehicle orchestration system which utilizes inter-vehicle communications to achieve orchestrated travel or orchestrated work between a work vehicle that is traveling via human driving and a work vehicle that is performing unmanned self-traveling.

### SUMMARY OF THE INVENTION

When a plurality of agricultural machines perform agricultural tasks, agricultural tasks for the same field may conflict between two or more agricultural machines. It is desired to appropriately manage access of agricultural machines to a field.

The present specification discloses solutions as recited in the following Items.

### Item 1

A management system for managing access of a plurality of agricultural machines to a field, the management system including a processor configured or programmed to, while a first agricultural machine among the plurality of agricultural machines is performing an agricultural task in the field and if a conflict of agricultural tasks for the field exists between the first agricultural machine and a second agricultural machine among the plurality of agricultural machines, allow at least one of the first agricultural machine and the second agricultural machine determined based on priority data to perform the agricultural task for the field.

### Item 2

The management system of Item 1, further including a storage to store the priority data that includes information of a respective priority level assigned in accordance with a kind of agricultural task to be performed by each of the plurality of agricultural machines.

### Item 3

The management system of Item 1, wherein, when the priority level of the second agricultural machine is higher than the priority level of the first agricultural machine, the processor is configured or programmed to allow the second agricultural machine to perform the agricultural task for the field with priority over the first agricultural machine.

### Item 4

The management system of Item 3, wherein, when the priority level of the second agricultural machine is higher than the priority level of the first agricultural machine, the processor is configured or programmed to cause the first agricultural machine to stop the agricultural task for the field, and allow the second agricultural machine to perform the agricultural task for the field.

### Item 5

The management system of Item 4, wherein, when causing the first agricultural machine to stop the agricultural task for the field, the processor is configured or programmed to further cause the first agricultural machine to exit the field.

### Item 6

The management system of Item 2, wherein, when the priority level of the first agricultural machine and the priority level of the second agricultural machine are equal, the processor is configured or programmed to allow the first agricultural machine and the second agricultural machine to perform the agricultural tasks for the field.

### Item 7

The management system of Item 6, wherein, when the priority level of the first agricultural machine and the priority level of the second agricultural machine are equal, the processor is configured or programmed to allow the first agricultural machine to continue the agricultural task for the field, and further allows the second agricultural machine perform the agricultural task for the field.

### Item 8

The management system of Item 4, wherein, after the agricultural task by the second agricultural machine for another field distinct from the field is finished, in response to receiving a notification of completion of the agricultural task transmitted from the second agricultural machine, the processor is configured or programmed to allow the second agricultural machine to perform the agricultural task for the field.

### Item 9

The management system of Item 1, wherein, when a conflict of agricultural tasks for the field exists between the first agricultural machine, the second agricultural machine, and a third agricultural machine among the plurality of agricultural machines, the processor is configured or programmed to allow an agricultural machine to which a highest priority level is assigned among the first agricultural machine, the second agricultural machine, and the third agricultural machine to perform the agricultural task for the field.

### Item 10

The management system of Item 2, wherein the priority data further includes information of a priority level assigned to an agricultural worker that is higher than the priority level of the second agricultural machine; and while the agricultural worker is performing an agricultural task in the field, if the second agricultural machine is trying to access the field, the processor is configured or programmed to disallow the second agricultural machine to perform the agricultural task for the field, based on the priority data.

### Item 11

The management system of Item 2, wherein the priority data further includes information of a priority level assigned to an agricultural worker that is higher than the priority level of the second agricultural machine; and while the agricultural worker is performing an agricultural task in the field, if the second agricultural machine is trying to access the field, the processor is configured or programmed to notify a terminal apparatus being used by the agricultural worker that the second agricultural machine is trying to access the field.

### Item 12

The management system of Item 1, wherein the processor is configured or programmed to manage a schedule of agricultural tasks to be performed by each of the plurality of agricultural machines.

### Item 13

The management system of Item 12, wherein, when causing the first agricultural machine to exit the field while the first agricultural machine is performing an agricultural task in the field, the processor is configured or programmed to update the schedule of agricultural tasks to be performed by the first agricultural machine.

### Item 14

A management system for managing access to a field between an agricultural machine and an agricultural worker, the management system including a storage to store priority data including information of a priority level of the agricultural machine that is assigned to the agricultural machine and a priority level that is assigned to the agricultural worker and is higher than the priority level of the agricultural machine; and a processor configured or programmed to, if a conflict of agricultural tasks for the field exists between the agricultural machine and the agricultural worker while the agricultural worker is performing the agricultural task in the field, allow the agricultural worker to continue the agricultural task for the field with priority over the agricultural machine, based on the priority data.

### Item 15

A computer-implemented method for managing access of a plurality of agricultural machines to a field, the method causing a computer to while a first agricultural machine among the plurality of agricultural machines is performing an agricultural task in the field, if a conflict of agricultural tasks for the field exists between the first agricultural machine and a second agricultural machine among the plurality of agricultural machines, allow at least one of the first agricultural machine and the second agricultural machine that is determined based on priority data to perform the agricultural task for the field.

### Item 16

A computer-implemented method for managing access to a field between an agricultural machine and an agricultural worker, the method causing a computer to read from a storage, priority data including information of a priority level of the agricultural machine that is assigned to the agricultural machine and a priority level that is assigned to the agricultural worker and is higher than the priority level of the agricultural machine; and if a conflict of agricultural tasks for the field exists between the agricultural machine and the agricultural worker while the agricultural worker is performing the agricultural task in the field, allow the agricultural worker to continue the agricultural task for the field with priority over the agricultural machine, based on the priority data.

General or specific aspects of various example embodiments of the present disclosure may be implemented using a device, a system, a method, an integrated circuit, a computer program, a non-transitory computer-readable storage medium, or any combination thereof. The non-transitory computer-readable storage medium may be inclusive of a volatile storage medium, or a non-volatile storage medium. The device may include a plurality of devices. In the case where the device includes two or more devices, the two or more devices may be provided within a single apparatus, or divided over two or more separate apparatuses.

According to example embodiments of the present disclosure, it is possible to appropriately manage access of agricultural machines to fields.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram schematically showing an example configuration of a management system according to an illustrative example embodiment of the present disclosure.

FIG. 2 is a block diagram illustrating a schematic hardware configuration of a server computer.

FIG. 3 is a block diagram illustrating a schematic hardware configuration of a terminal apparatus.

FIG. 4 is a perspective view showing an example appearance of an agricultural machine according to an illustrative example embodiment of the present disclosure.

FIG. 5 is a side view schematically showing an example of an agricultural machine having an implement attached thereto.

FIG. 6 is a block diagram showing an example schematic configuration of an agricultural machine.

FIG. 7 is a conceptual diagram showing an example agricultural machine which performs positioning based on an RTK-GNSS.

FIG. 8 is a diagram schematically showing an example of an agricultural machine automatically traveling along a target path in a field.

FIG. 9 is a flowchart showing an example operation of steering control to be performed by a controller during self-driving.

FIG. 10A is a diagram showing an example of an agricultural machine that travels along a target path.

FIG. 10B is a diagram showing an example of an agricultural machine at a position which is shifted rightward from the target path.

FIG. 10C is a diagram showing an example of an agricultural machine at a position which is shifted leftward from the target path.

FIG. 10D is a diagram showing an example of an agricultural machine which is oriented in an inclined direction with respect to the target path.

FIG. 11 is a diagram schematically showing an example situation where a plurality of agricultural machines are self-traveling inside a field and on a road outside the field.

FIG. 12 is a diagram showing an example of a setting screen for a task schedule that is displayed on a display device of the terminal apparatus.

FIG. 13 is a diagram showing an example of a schedule of agricultural tasks to be generated by the server.

FIG. 14A is a diagram showing an example relationship between agricultural tasks and priority levels.

FIG. 14B is a diagram showing another example of a schedule of agricultural tasks that is generated by the server.

FIG. 14C is a diagram showing an example of a table that associates agricultural machine IDs and the priority levels of agricultural machines.

FIG. 15 is a flowchart illustrating the procedure of a method of managing access to a field according to an illustrative example embodiment of the present disclosure.

FIG. 16A is a diagram for describing a method of managing access to a field according to a first example.

FIG. 16B is a diagram for describing the method of managing access to a field according to the first example.

FIG. 17A is a diagram for describing a method of managing access to a field according to a second example.

FIG. 17B is a diagram for describing the method of managing access to a field according to the second example.

FIG. 18A is a diagram for describing a method of managing access to a field according to a third example.

FIG. 18B is a diagram for describing the method of managing access to a field according to the third example.

FIG. 19A is a diagram for describing a method of managing access to a field according to a fourth example.

FIG. 19B is a diagram for describing the method of managing access to a field according to the fourth example.

FIG. 19C is a diagram for describing the method of managing access to a field according to the fourth example.

FIG. 20A is a diagram showing an example of a table that associates agricultural workers and priority levels.

FIG. 20B is a still another example of a schedule of agricultural tasks that is generated by the server.

FIG. 21A is a diagram schematically showing an agricultural worker performing an agricultural task in a field.

FIG. 21B is a diagram for describing, when an agricultural worker is performing an agricultural task in the field, urging the agricultural worker to exit the field if a conflict of agricultural tasks exists with an agricultural machine.

FIG. 22 is a diagram showing an example of a pop-up indication on a display of the terminal apparatus.

### DETAILED DESCRIPTION OF THE EXAMPLE EMBODIMENTS

Hereinafter, example embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only exemplary, and the techniques according to the present disclosure is not limited to the following example embodiments. For example, numerical values, shapes, materials, steps, and orders of steps, layout of a display screen, etc., that are indicated in the following example embodiments are only exemplary, and admit of various modifications so long as it makes technological sense. Any one implementation may be combined with another so long as it makes technological sense to do so.

In the present disclosure, an “agricultural machine” means a machine for agricultural applications. Examples of agricultural machines include tractors, harvesters, rice transplanters, vehicles for crop management, vegetable transplanters, mowers, seeders, spreaders, and mobile robots for use in fields. Not only may a work vehicle (such as a tractor) function as an “agricultural machine” alone by itself, but also an implement that is attached to or towed by a work vehicle may together in combination with the work vehicle function as an “agricultural machine”. For the ground surface within a field, an agricultural machine performs agricultural work such as tilling, seeding, preventive pest control, manure spreading, planting of crops, or harvesting. Such agricultural work or tasks may be referred to simply as “work” or “tasks”.

In the present disclosure, “self-driving” includes controlling the movement of an agricultural machine by the action of a controller, rather than through manual operations of a driver. An agricultural machine that performs self-driving may be referred to as a “self-driving agricultural machine” or a “robotic agricultural machine”. During self-driving, not only the movement of the agricultural machine, but also the operation of agricultural work may also be controlled automatically. In the case where the agricultural machine is a vehicle-type machine, traveling of the agricultural machine via self-driving will be referred to as “self-traveling”. The controller may be configured or programmed to control at least one of: steering that is required in the movement of the agricultural machine; adjustment of the moving speed; and beginning and ending a move. In the case of controlling a work vehicle having an implement attached thereto, the controller may be configured or programmed to control operations such as raising or lowering of the implement, beginning and ending of an operation of the implement, and so on. A move based on self-driving may include not only moving of an agricultural machine that goes along a predetermined path toward a destination, but also moving of an agricultural machine that follows a target of tracking. An agricultural machine that performs self-driving may also have the function of moving partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of an agricultural machine will be referred to as “automatic steering”. A portion or an entirety of the controller may reside outside the agricultural machine. Control signals, commands, data, etc., may be communicated between the agricultural machine and a controller residing outside the agricultural machine. An agricultural machine that performs self-driving may move autonomously while sensing the surrounding environment, without any person being involved in the controlling of the movement of the agricultural machine. An agricultural machine that is capable of autonomous movement is able to travel within the field or outside the fields (e.g., on roads) in an unmanned manner. During an autonomous move, operations of detecting and avoiding obstacles may be performed.

A management system according to an example embodiment of the present disclosure is, in effect, realized as a computer system. The management system includes a processing unit. The aforementioned controller may be configured or programmed to function as a processing unit. Based on priority levels which are respectively assigned to a plurality of agricultural machines, the processing unit is configured or programmed to manage access of the plurality of agricultural machines to a field. When any conflict of agricultural tasks exists among the plurality of agricultural machines for the same field, the processing unit is configured or programmed to perform a process to permit one or more agricultural machines, as determined based on priority data, to have access to the field. For example, for each agricultural machine, a priority level may be assigned in accordance with the kind of agricultural task to be performed by the respective one of the plurality of agricultural machines. The agricultural machine that is permitted access to the field may move to the field and perform the agricultural task.

The processing unit may be a computer that includes one or more processors and one or more memories, for example. In that case, the processor may consecutively execute a computer program that is stored in the memory (s) to achieve a desired process. The processing unit may be mounted on the agricultural machine, or located at a place that is remote from the agricultural machine, e.g., at the home or the office of a user who monitors the agricultural machine. One of multiple electronic control units (ECU) that is mounted on the agricultural machine may function as the processing unit, or an ECU that is mounted on one of a plurality of agricultural machines may be designated as a master computer to function as the processing unit. Alternatively, an external server computer or an edge computer that communicates with the agricultural machine via a network may be configured or programmed to function as the processing unit. Furthermore, a terminal apparatus may be configured or programmed to function as the processing unit. Examples of terminal apparatuses include stationary type computers, smartphones, tablet computers, laptop computers, or the like.

While a first agricultural machine among a plurality of agricultural machines is performing an agricultural task for a field, if a conflict of agricultural tasks for the field exists between the first agricultural machine and a distinct second agricultural machine among the plurality of agricultural machines, a processing unit according to an aspect of an example embodiment of the present disclosure is configured or programmed to allow at least one of the first agricultural machine and the second agricultural machine that is determined based on priority data to perform the agricultural task for the field. When the priority level of the second agricultural machine is higher than the priority level of the first agricultural machine, the processing unit is configured or programmed to allow the second agricultural machine to perform the agricultural task for the field with priority over the first agricultural machine. For example, the processing unit may be configured or programmed to cause the first agricultural machine to stop the agricultural task for the field, and instead allow the second agricultural machine to perform the agricultural task for the field. As a result of the processing unit processing access to the field, the first agricultural machine of a low priority level concedes the agricultural task for the field to the second agricultural machine of a high priority level.

Consider a case where an agricultural worker manually manipulates an agricultural machine to perform an agricultural task or move. In this case, even if a conflict of agricultural tasks for the field exists, for example, agricultural workers may communicate with one another; and in accordance with the content of the agricultural tasks or a task schedule, they may concede their agricultural tasks for the field to an agricultural worker who is to perform a task of a high priority level. As used herein, by saying that a conflict of agricultural tasks for the field exists, it is meant that, for example: when a certain agricultural machine is already performing an agricultural task in a field, another agricultural machine subsequently tries to performing an agricultural task in the field; or, when no agricultural machines are performing agricultural tasks in a field, two or more agricultural machines attempt to perform their agricultural tasks in the field. An agricultural worker who is to perform a task of a low priority level may be made to wait until the agricultural task for the field ends, perform manual work while leaving the agricultural machine alone, or abandon the agricultural task for the field altogether and consider performing an agricultural task in another field, for example. Alternatively, in accordance with the content of the agricultural tasks or a task schedule, an administrator who manages the entirety of agricultural tasks may decide the agricultural worker who is to perform an agricultural task for the field as appropriate. However, if this decision includes a human error, an agricultural task of a high priority level may be postponed, for example, thus resulting in inefficiency.

In contrast, according to an example embodiment of the present disclosure, priority levels are assigned to agricultural machines, and the agricultural machine to be allowed to perform an agricultural task is determined based on the priority levels, whereby streamlining of tasks can be achieved even in the presence of a conflict of agricultural tasks for the field.

When the priority level of the first agricultural machine and the priority level of the second agricultural machine are equal, a processing unit according to another aspect of an example embodiment of the present disclosure may be configured or programmed to allow the first agricultural machine and the second agricultural machine to perform agricultural tasks for the field. By allowing two or more agricultural machines to perform agricultural tasks in the same field, the agricultural work can be accelerated.

When a conflict of agricultural tasks for the field exists between an agricultural worker and an agricultural machine, a processing unit according to still another aspect of an example embodiment of the present disclosure may be configured or programmed to allow the agricultural worker to continue the agricultural task for the field with priority over the agricultural machine, based on priority data. Preferably, a priority level that is higher than the priority level of any agricultural machine is assigned to an agricultural worker. As a result, the agricultural worker can be allowed to continue the agricultural task without being interfered by the agricultural machines.

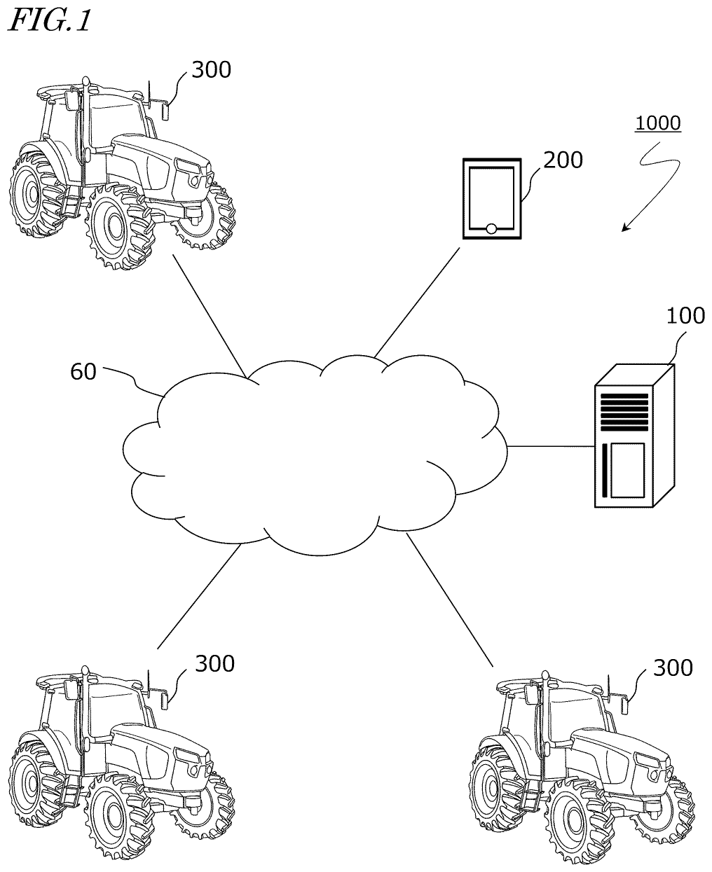

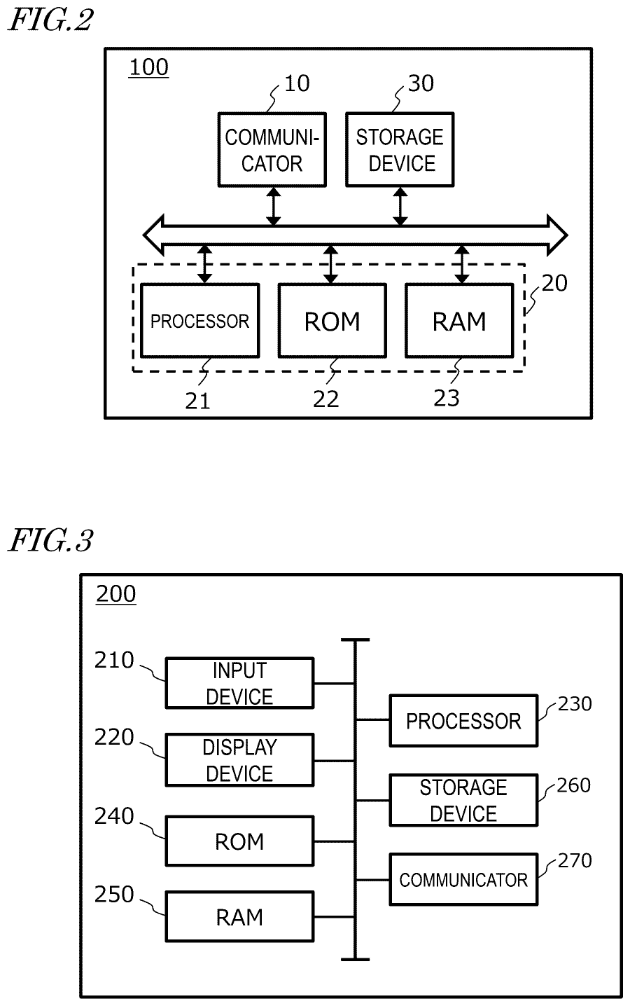

FIG. 1 is a diagram schematically showing an example configuration of a management system 1000 according to the present example embodiment. FIG. 2 is a block diagram illustrating a schematic hardware configuration of a server computer 100. The management system 1000 includes a server computer 100 (hereinafter denoted as the “server 100”) and one or more terminal apparatuses 200. Via a wired or wireless network 60, the plurality of agricultural machines 300 may be connected to the management system 1000 in such a manner that they are capable of communicating with one another. FIG. 1 shows an example connection where three agricultural machines 300 are connected to the management system 1000 via the network 60. However, any number of agricultural machines 300 may be connected to the management system 1000. For example, all of a plurality of agricultural machines that are possessed by an agricultural administrator may be connected to the management system 1000. From the standpoint of reducing communication delays and dispersing the network load, the management system 1000 may further include one or more edge computers. In the present example embodiment, a portion of the server 100 is configured or programmed to function as a processing unit.

The server 100 may be a computer that is located at a remote place from the agricultural machine 300. The server 100 includes a communicator 10, a processing unit 20, and a storage 30. These component elements are connected to one another via a bus so as to be capable of communicating with another. The server 100 can function as a cloud server that provides centralized management of a schedule of agricultural tasks to be performed by agricultural machines in a field, and assists in agriculture by using the data that it manages. For example, the user may generate a task schedule by using a terminal apparatus 200, and upload it to the server 100 via the network 60.

The communicator 10 is a communication module for communicating with the terminal apparatus 200 and the agricultural machines 300 via the network 60. For example, the communicator 10 is able to perform wired communications compliant with communication standards such as IEEE1394 (registered trademark) or Ethernet (registered trademark). For example, the communicator 10 is able to perform wireless communications compliant with the Bluetooth (registered trademark) standards or the Wi-Fi standards, or 3G, 4G, 5G or other cellular mobile communications.

The processing unit 20 includes a processor 21, a ROM (Read Only Memory) 22, a RAM (Random Access Memory) 23, and the like, for example. Software (or firmware) for the processor 21 to perform at least one process may be implemented in the ROM 22. Such software may be recorded on a non-transitory computer-readable storage medium, e.g., an optical disc, and marketed as packaged software, or provided to the user via the network 60.

The processor 21 may include a semiconductor integrated circuit, and a central processor (CPU). The processor 21 may be realized as a microprocessor or microcontroller. The processor 21 consecutively executes a computer program stored in the ROM 22, in which instructions for executing at least one process are described, to realize desired processes.

In addition to or instead of the processor 21 the processing unit 20 may include an FPGA (Field Programmable Gate Array), a GPU (Graphics Processor), an ASIC (Application Specific Integrated Circuit), an ASSP (Application Specific Standard Product) having a CPU mounted therein, or a combination of two or more circuits selected from among such circuits.

The ROM 22 is a writable memory (e.g., a PROM), a rewritable memory (e.g., a flash memory), or a read-only memory, for example. The ROM 22 stores a program to control the operation of the processor 21. The ROM 22 may not be a single storage medium, but may be a set of storage media. A portion of the set of storage media may be removable memory.

The RAM 23 provides a work area into which the control program stored in the ROM 22 will be temporarily laid out during boot-up. The RAM 23 may not necessarily be a single storage medium, and may be a set of storage media.

The storage 30 mainly functions as a storage for databases. An example of the storage 30 is a cloud storage. The storage 30 may be a magnetic storage or a semiconductor storage, for example. An example of a magnetic storage is a hard disk drive (HDD). An example of a semiconductor storage is a solid state drive (SSD). However, the storage 30 may be an external storage that is connected to the server 100 via the network 60.

FIG. 3 is a block diagram illustrating a schematic hardware configuration of the terminal apparatus 200.

The terminal apparatus 200 includes an input device 210, a display device 220, a processor 230, a ROM 240, a RAM 250, a storage 260, and a communicator 270. These component elements are connected to one another via a bus so as to be capable of communicating with another.

The input device 210 is a device that converts instructions from the user into data and inputs it to a computer. Examples of the input device 210 are a keyboard, a mouse, and a touchscreen panel. Examples of the display device 220 are a liquid crystal display and an organic EL display. The description of each of the processor 230, the ROM 240, the RAM 250, the storage 260, and the communicator 270 has already been given in the hardware configuration example of the server 100, and is omitted.

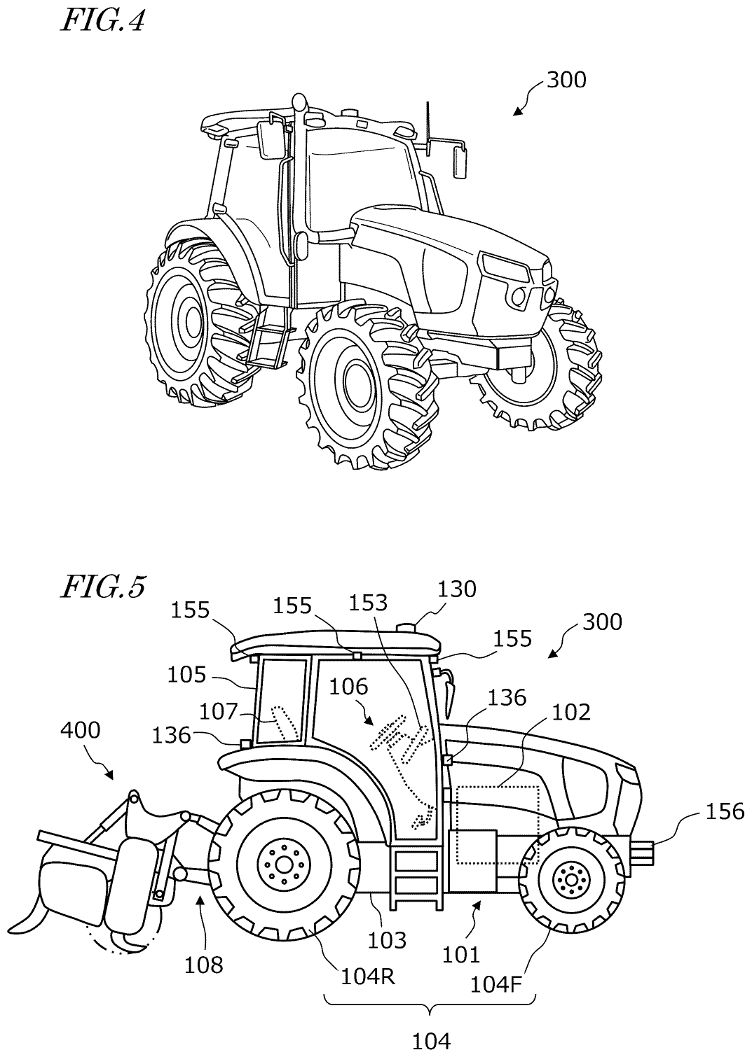

FIG. 4 is a perspective view showing an example appearance of the agricultural machine 300 according to the present example embodiment. FIG. 5 is a side view schematically showing an example of the agricultural machine 300 having an implement 400 attached thereto. The agricultural machine 300 according to the present example embodiment is agricultural tractor (work vehicle) having the implement 400 attached thereto. The agricultural machine 300 is not limited to a tractor, and may not have the implement 400 attached thereto.

As shown in FIG. 5, the agricultural machine 300 includes a vehicle body 101, a prime mover (engine) 102, and a transmission 103. On the vehicle body 101, tires (wheels) 104 and a cabin 105 are provided. The tires 104 include a pair of front wheels 104F and a pair of rear wheels 104R. Inside the cabin 105, a driver's seat 107, a steering device 106, an operational terminal 153, and switches for manipulation are provided. In the case where the agricultural machine 300 does not travel on public roads, either pair of the front wheels 104F or the rear wheels 104R may be crawlers, rather than tires.

The agricultural machine 300 shown in FIG. 5 further includes a plurality of cameras 155. The cameras 155 may be provided at the front/rear/right/left of the agricultural machine 300, for example. The cameras 155 capture images of the surrounding environment of the agricultural machine 300, and generate image data. The images acquired by the cameras 155 may be transmitted to the terminal apparatus 200 which is responsible for remote monitoring. The images may be used to monitor the agricultural machine 300 during unmanned driving. The cameras 155 may also be used in order to generate images for recognizing white lines, signs, indications, or obstacles in the surroundings when the agricultural machine 300 travels on a road.

The agricultural machine 300 further includes the positioning device 130. The positioning device 130 includes a GNSS receiver. The GNSS receiver includes an antenna to receive a signal (s) from a GNSS satellite(s) and a processing circuit to determine the position of the agricultural machine 300 based on the signal (s) received by the antenna. The positioning device 130 receive a GNSS signal (s) transmitted from a GNSS satellite (s), and performs positioning on the basis of the GNSS signal (s). GNSS is a general term for satellite positioning systems, such as GPS (Global Positioning System), QZSS (Quasi-Zenith Satellite System, e.g., MICHIBIKI), GLONASS, Galileo, BeiDou, and the like. Although the positioning device 130 in the present example embodiment is located above the cabin 105, it may be located at any other position.

The positioning device 130 may include an inertial measurement unit (IMU). It is possible to complement the position data by using a signal from the IMU. The IMU can measure tilts and minute motions of the agricultural machine 300. By complementing the position data based on satellite signals using the data acquired by the IMU, the positioning performance can be improved.

The agricultural machine 300 illustrated in FIG. 5 further includes an LiDAR sensor 156. The LiDAR sensor 156 in this example is The LiDAR sensor 156 in this example is located at a lower portion of the front surface of the vehicle body 101. The LiDAR sensor 156 may alternatively be located at other positions. While the agricultural machine 300 is moving, the LiDAR sensor 156 repetitively outputs sensor data representing the distances and directions of measurement points on objects existing in the surrounding environment, or two-dimensional or three-dimensional coordinate values of such measurement points. The sensor data which is output from the LiDAR sensor 156 is processed by the controller of the agricultural machine 300. By utilizing SLAM (Simultaneous Localization and Mapping) or other algorithms, for example, the controller is able to perform processes such as generating an environment map based on the sensor data. The generation of an environment map may be performed by a computer, e.g., the server 100, that is external to the agricultural machine 300. The sensor data that is output from the LiDAR sensor 156 may also be utilized for obstacle detection.

The positioning device 130 may utilize the data acquired by the cameras 155 or the LiDAR sensor 156 for positioning. When objects serving as characteristic points exist in the environment that is traveled by the agricultural machine 300, the position of the agricultural machine 300 can be estimated with a high accuracy based on data that is acquired with the cameras 155 or the LiDAR sensor 156 and an environment map that is previously recorded in the storage. By correcting or complementing position data based on the satellite signal (s) using the data acquired by the cameras 155 or the LiDAR sensor 156, it becomes possible to identify the position of the agricultural machine 300 with a higher accuracy.

The agricultural machine 300 further includes a plurality of obstacle sensors 136. In the example shown in FIG. 5, the obstacle sensors 136 are provided at the front and the rear of the cabin 105. The obstacle sensors 136 may be used for detecting obstacles in the surroundings during self-traveling to come to a halt or detour around it.

The prime mover 102 may be a diesel engine, for example. Instead of a diesel engine, an electric motor may be used. The transmission 103 can change the propulsion and the moving speed of the agricultural machine 300 through a speed changing mechanism. The transmission 103 can also switch between forward travel and backward travel of the agricultural machine 300.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the agricultural machine 300. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of a controller located in the agricultural machine 300, the steering angle may be automatically adjusted by the power of the hydraulic device or electric motor.

A linkage device 108 is provided at the rear of the vehicle body 101. The linkage device 108 may include, e.g., a three-point linkage (also referred to as a “three-point link” or a “three-point hitch”), a PTO (Power Take Off) shaft, a universal joint, and a communication cable. The linkage device 108 allows the implement 400 to be attached to or detached from the agricultural machine 300. While towing the implement 400, the agricultural machine 300 allows the implement 400 to perform a predetermined task. The linkage device 108 may be provided frontward of the vehicle body 101. In that case, the implement may be connected frontward of the agricultural machine 300.

Although the agricultural machine 300 illustrated in FIG. 5 is a rotary tiller, the implement 400 is not limited to a rotary tiller. For example, any arbitrary implement such as a seeder, a spreader, a transplanter, a mower, a harvester, a sprayer, or a harrow, may be connected to the agricultural machine 300 for use.

The agricultural machine 300 illustrated in FIG. 5 is capable of human driving; alternatively, it may only support unmanned driving. In that case, component elements which are only required for human driving, e.g., the cabin 105, the steering device 106, and the driver's seat 107 do not need to be provided in the agricultural machine 300. An unmanned agricultural machine 300 may travel via autonomous driving, or by remote manipulation by a user.

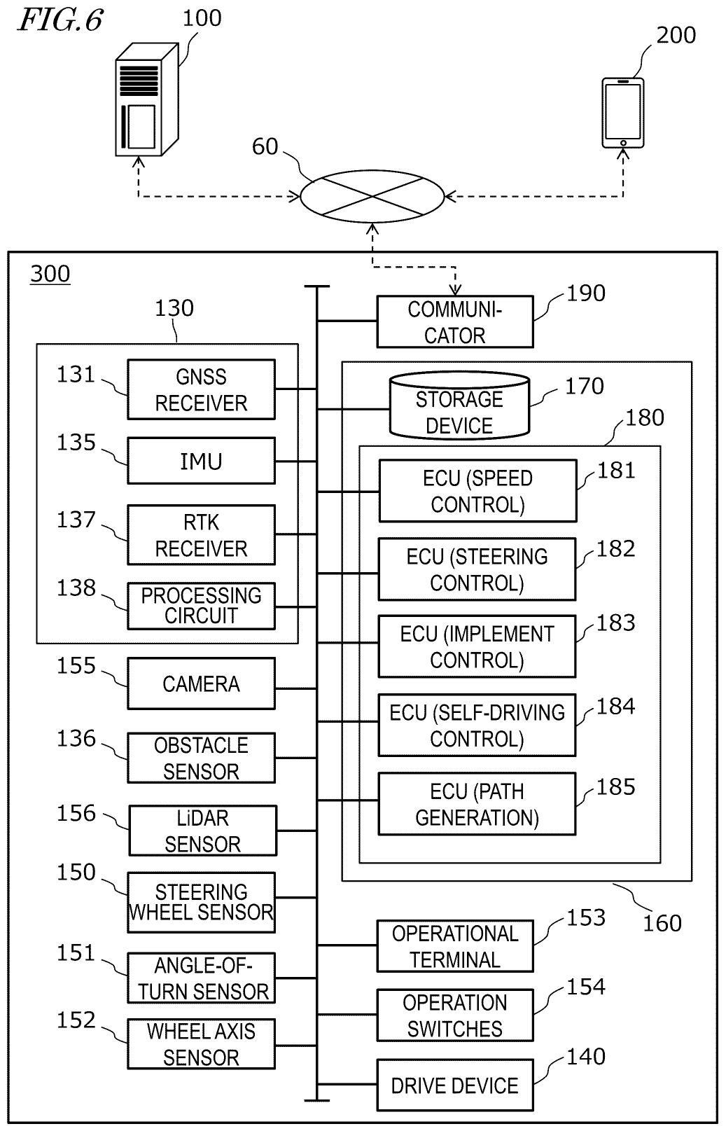

FIG. 6 is a block diagram showing an example schematic configuration of the agricultural machine 300. The agricultural machine 300 and the implement 400 can communicate with each other via a communication cable that is included in the linkage device 108.

In addition to the cameras 155, the positioning device 130, the obstacle sensors 136, and the operational terminal 153, the agricultural machine 300 in the example of FIG. 6 includes a drive device 140, steering wheel sensor 150, an angle-of-turn sensor 151, a wheel axis sensor 152, operation switches 154, a control system 160, and a communicator 190.

The positioning device 130 includes a GNSS receiver 131, and an inertial measurement unit 135. The control system 160 includes a storage 170 and a controller 180. The controller 180 includes a plurality of electronic control units 181 to 185. Note that FIG. 6 shows component elements which are relatively closely related to the operations of self-driving by the agricultural machine 300, while other component elements are omitted from illustration.

The GNSS receiver 131 in the positioning device 130 receive satellite signals which are transmitted from multiple GNSS satellites, and generate GNSS data based on the satellite signals. The GNSS data may be generated in a predetermined format, such as the NMEA-0183 format, for example. The GNSS data may contain values representing the identification number, angle of elevation, azimuth angle, and reception intensity of each satellite from which a satellite signal was received, for example.

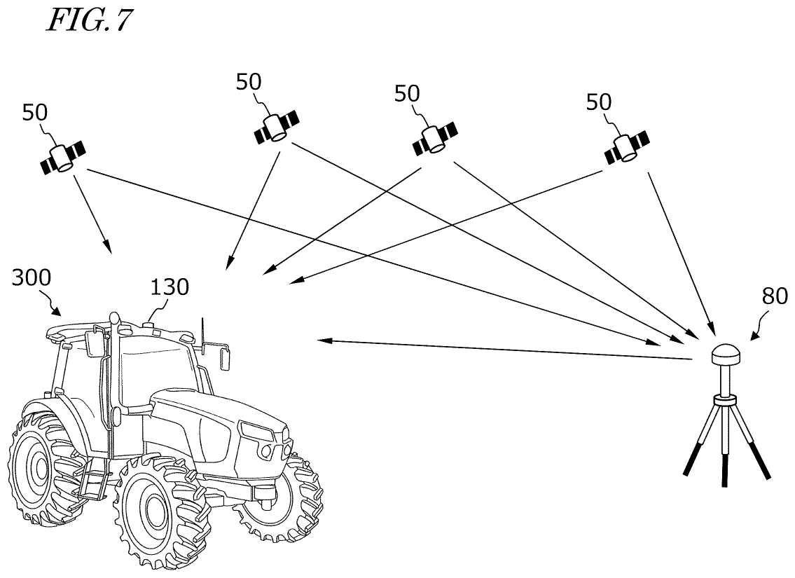

The positioning device 130 shown in FIG. 6 performs positioning of the agricultural machine 300 by utilizing an RTK (Real Time Kinematic)-GNSS. FIG. 7 is a conceptual diagram showing an example of the agricultural machine 300 which performs positioning based on an RTK-GNSS. In the positioning based on an RTK-GNSS, not only satellite signals transmitted from multiple GNSS satellites 50, but also a correction signal that is transmitted from a reference station 80 is used. The reference station 80 may be located near the field that is traveled by the agricultural machine 300 (e.g., at a position within 1 km of the agricultural machine 300). The reference station 80 generates a correction signal of, e.g., an RTCM format based on the satellite signals received from the multiple GNSS satellites 50, and transmits the correction signal to the positioning device 130. The RTK receiver 137, which includes an antenna and a modem, receives the correction signal transmitted from the reference station 80. Based on the correction signal, the processing circuit 138 of the positioning device 130 corrects the result of positioning by the GNSS receiver 131. Use of an RTK-GNSS enables positioning with an accuracy on the order of several cm of errors, for example. Positional information (including latitude, longitude, and altitude information) is acquired through the highly accurate positioning by an RTK-GNSS. The positioning device 130 may calculate the position of the agricultural machine 300 as frequently as, e.g., one to ten times per second.

Note that the positioning method is not limited to an RTK-GNSS; any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 80, positional information may be generated without using the correction signal. In that case, the positioning device 130 may lack the RTK receiver 137.

The positioning device 130 in the present example embodiment further includes an IMU 135. The IMU 135 includes a 3-axis accelerometer and a 3-axis gyroscope. The IMU 135 may include a direction sensor such as a 3-axis geomagnetic sensor. The IMU 135 functions as a motion sensor which can output signals representing parameters as such acceleration, velocity, displacement, and attitude of the agricultural machine 300. Based not only on the GNSS signals and the correction signal but also on a signal that is output from the IMU 135, the positioning device 130 can estimate the position and orientation of the agricultural machine 300 with a higher accuracy. The signal that is output from the IMU 135 may be used for the correction or complementation of the position that is calculated based on the satellite signals and the correction signal. The IMU 135 outputs a signal more frequently than does the GNSS receiver 131. Utilizing this highly frequent signal, the processing circuit 138 can measure the position and orientation of the agricultural machine 300 more frequently (e.g., about 10 Hz or above). Instead of the IMU 135, a 3-axis accelerometer and a 3-axis gyroscope may be separately provided. The IMU 135 may be provided as a separate device from the positioning device 130.

In the example of FIG. 6, the processing circuit 138 calculates the position of the agricultural machine 300 based on signals which are output from the GNSS receiver 131, the RTK receiver 137, and the IMU 135. Furthermore, the processing circuit 138 may estimate or correct the position of the agricultural machine 300 based on data that is acquired by the cameras 155 or the LiDAR sensor 156. By using the data acquired by the cameras 155 or the LiDAR sensor 156, the accuracy of positioning can be further enhanced.

The positional calculation may instead be performed by any device other than the positioning device 130. For example, the controller 180 or an external computer may acquire output data from the each receiver and each sensor as is required for positioning, and estimate the position of the agricultural machine 300 based on such data.

The cameras 155 are imagers that image the surrounding environment of the agricultural machine 300. Each camera 155 may include an image sensor such as a CCD (Charge Coupled Device) or a CMOS (Complementary Metal Oxide Semiconductor), for example. In addition, each camera 155 may include an optical system including one or more lenses and a signal processing circuit. During travel of the agricultural machine 300, the cameras 155 image the surrounding environment of the agricultural machine 300, and generate image (e.g., motion picture) data. The cameras 155 are able to capture motion pictures at a frame rate of 3 frames/second (fps: frames per second) or greater, for example. The images generated by the cameras 155 may be used when a remote supervisor checks the surrounding environment of the agricultural machine 300 with the terminal apparatus 200, for example. The images generated by the cameras 155 may also be used for the purpose of positioning or obstacle detection. As shown in FIG. 5, a plurality of cameras 155 may be provided at different positions on the agricultural machine 300, or a single camera may be provided. A visible camera (s) for generating visible images and an infrared camera (s) for generating infrared images may be separately provided. Both of a visible camera (s) and an infrared camera (s) may be provided as cameras for generating images for monitoring purposes. Infrared cameras may also be used for obstacle detection at nighttime.

The obstacle sensors 136 detect objects around the agricultural machine 300. Each obstacle sensor 136 may include a laser scanner or an ultrasonic sonar, for example. When an object exists at a position closer to the obstacle sensor 136 than a predetermined distance, the obstacle sensor 136 outputs a signal indicating the presence of an obstacle. A plurality of obstacle sensors 136 may be provided at different positions of the agricultural machine 300. For example, a plurality of laser scanners and a plurality of ultrasonic sonars may be located at different positions of the agricultural machine 300. Providing a multitude of obstacle sensors 136 can reduce blind spots in monitoring obstacles around the agricultural machine 300.

The drive device 140 includes various devices that are needed for the traveling of the agricultural machine 300 and the driving of the implement 400, e.g., the aforementioned prime mover 102 and transmission 103, a differential including a locking differential mechanism, the steering device 106, and the linkage device 108, for example. The prime mover 102 may include an internal combustion engine such as a diesel engine. Instead of an internal combustion engine or in addition to an internal combustion engine, the drive device 140 may include an electric motor that is dedicated to traction purposes.

The steering wheel sensor 150 measures the angle of rotation of the steering wheel of the agricultural machine 300. The angle-of-turn sensor 151 measures the angle of turn of the front wheels 104F, which are the wheels responsible for steering. Measurement values by the steering wheel sensor 150 and the angle-of-turn sensor 151 are used for steering control by the controller 180.

The wheel axis sensor 152 measures the rotational speed, i.e., the number of revolutions per unit time, of a wheel axis that is connected to a tire 104. The wheel axis sensor 152 may be a sensor utilizing a magnetoresistive element (MR), a Hall generator, or an electromagnetic pickup, for example. The wheel axis sensor 152 may output a numerical value indicating the number of revolutions per minute (unit: rpm) of the wheel axis, for example. The wheel axis sensor 152 is used to measure the speed of the agricultural machine 300.

The storage 170 includes one or more storage media such as a flash memory or a magnetic disc. The storage 170 stores various data that is generated by the sensors and by the controller 180. In the storage 170, an environment map including the inside of the field and any public roads outside the field and information of target paths are previously recorded. In the case where one or more of a plurality of ECUs included in the controller 180 function (s) as the processing unit 20 according to the present example embodiment, a schedule of agricultural tasks to be performed by the agricultural machine 300, data of a work log, and the like may be stored in the storage 170, for example.

The controller 180 includes a plurality of ECUs. The plurality of ECUs may include, for example, an ECU 181 for speed control, an ECU 182 for steering control, an ECU 183 for implement control, an ECU 184 for self-driving control, and an ECU 185 for path generation, for example. The ECU 181 controls the prime mover 102, the transmission 103, and the brakes included in the drive device 140, thus controlling the speed of the agricultural machine 300. The ECU 182 controls the hydraulic device or electric motor included in the steering device 106 based on a measurement value of the steering wheel sensor 150, thus controlling the steering of the agricultural machine 300. In order to cause the implement 400 to perform a desired operation, the ECU 183 controls the operation of the three-point link, the PTO shaft, etc., that are included in the linkage device 108. Also, the ECU 183 generates a signal to control the operation of the implement 400, and transmits this signal from the communication device 190 to the implement 400. Based on signals which are output from the positioning device 130, the steering wheel sensor 150, the angle-of-turn sensor 151, and the wheel axis sensor 152, the ECU 184 performs computation and control for achieving self-driving. During self-driving, the ECU 184 sends a speed command value to the ECU 181, and sends a steering angle command value to the ECU 182. In response to the speed command value, the ECU 181 controls the prime mover 102, the transmission 103, or the brakes to change the speed of the agricultural machine 300. In response to the steering angle command value, the ECU 182 controls the steering device 106 to change the steering angle. The ECU 185 controls communications of the communicator 190 with other devices. For example, the ECU 185 generates a target path for the agricultural machine 300, and records it to the storage 170.

In the case where the processing unit 20 of the server 100 determines a next field for which to permit the agricultural machine 300 an agricultural task, the ECU 185 may receive the positional information of a next field that is transmitted from the processing unit 20, and generate a target path from the current point to the next field based on the received positional information of the next field, for example.

Through the action of these ECUs, the controller 180 achieves self-driving, determination of a target path, and communications with other devices. During self-driving, the controller 180 controls the drive device 140 based on the position of the agricultural machine 300 as measured or estimated by the positioning device 130 and the target path stored in the storage 170. As a result, the controller 180 causes the agricultural machine 300 to travel along the target path.

The plurality of ECUs included in the controller 180 may communicate with one another according to a vehicle bus standard such as CAN (Controller Area Network). Although the ECUs 181 to 185 are illustrated as individual corresponding blocks in FIG. 6, each of these functions may be implemented by a plurality of ECUs. Alternatively, an onboard computer that integrates the functions of at least some of the ECUs 181 to 185 may be provided. The controller 180 may include ECUs other than the ECUs 181 to 185, and any number of ECUs may be provided in accordance with functionality. For example, the controller 180 may further include an ECU to be used for managing access of the agricultural machine 300 to a field. Each ECU includes a control circuit including one or more processors.

The communication device 190 includes a circuit that performs communications with the communication IF of the implement 400. The communication device 190 includes circuitry to perform exchanges of signals complying with an ISOBUS standard such as ISOBUS-TIM, for example, between itself and the communication IF of the implement 400. This causes the implement 400 to perform a desired operation, or allows information to be acquired from the implement 400.

The operational terminal 153 is a terminal for the user to perform a manipulation related to the traveling of the agricultural machine 300 and the operation of the implement 400, and may also be referred to as a virtual terminal (VT). The operational terminal 153 may include a display device such as a touch screen panel, and/or one or more buttons. The display device may be a display such as a liquid crystal or an organic light-emitting diode (OLED), for example. By manipulating the operational terminal 153, the user can perform various manipulations, such as switching ON/OFF the self-driving mode, recording or editing an environment map, setting a target path, and switching ON/OFF the implement 400. At least some of these manipulations can also be realized by manipulating the operation switches 154. The operational terminal 153 may be configured so as to be detachable from the agricultural machine 300. A user who is remote from the agricultural machine 300 may manipulate the detached operational terminal 153 to control the operation of the agricultural machine 300. Instead of the operational terminal 153, the user may manipulate a computer on which necessary application software is installed, e.g., the terminal apparatus 200, to control the operation of the agricultural machine 300. The operational terminal 153 can also be used as a terminal apparatus to transmit a request signal to the server 100.

First, an example operation of self-traveling by the agricultural machine 300 will be described.

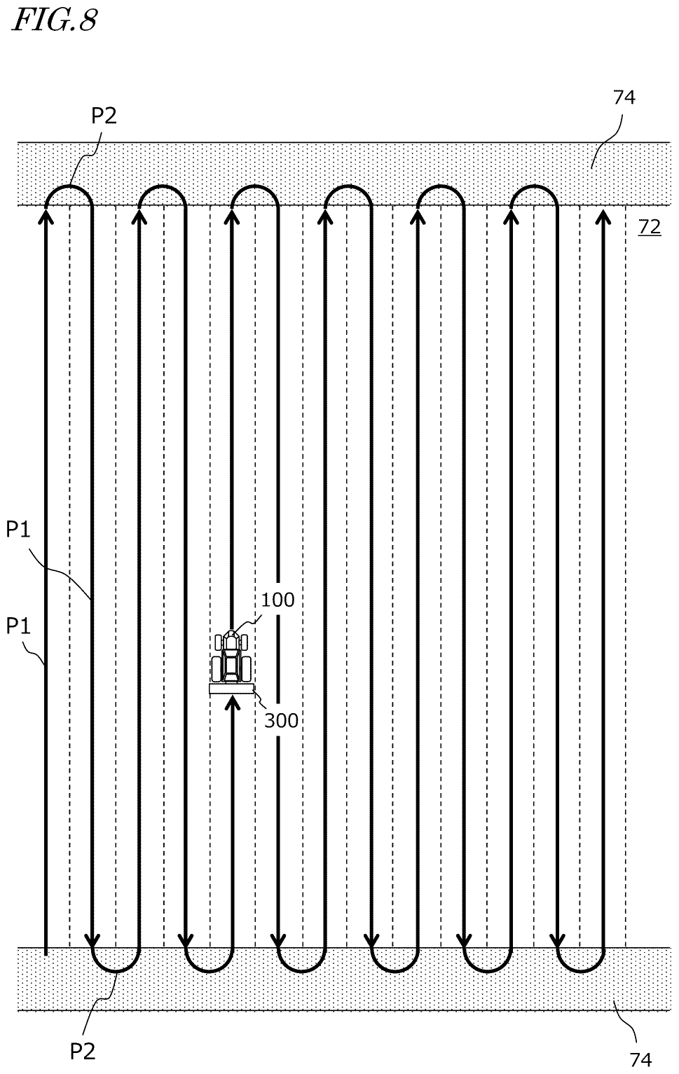

FIG. 8 is a diagram schematically showing an example of an agricultural machine 300 automatically traveling along a target path in a field. In this example, the field includes a work area 72 in which the agricultural machine 300 performs a task by using the implement 400, and headlands 74 that are located near the outer edge of the field. The user may designate which regions on the map of the field would correspond to the work area 72 and the headlands 74 in advance. The target path in this example includes a plurality of parallel main paths P1 and a plurality of turning paths P2 interconnecting the plurality of main paths P1. The main paths P1 are located in the work area 72, whereas the turning paths P2 are located in the headlands 74. Although each main path P1 in FIG. 8 is illustrated as a linear path, each main path P1 may also contain a curved portion (s). Broken lines in FIG. 8 depict the working breadth of the implement 400. The working breadth is previously set and recorded in the storage 170. The working breadth may be set and recorded as the user manipulates the operational terminal 153. Alternatively, the working breadth may be automatically recognized and recorded when the implement 400 is connected to the agricultural machine 300. The interval between the plurality of main paths P1 may be matched to the working breadth. The target path may be generated based on the user's manipulation, before self-driving is begun. The target path may be generated so as to cover the entire work area 72 in the field, for example. Along the target path shown in FIG. 8, the agricultural machine 300 automatically travels while reciprocating, from a beginning point of work to an ending point of work. Note that the target path shown in FIG. 8 is only an example, and the target path may be arbitrarily determined.

Next, an example control by the controller 180 during self-driving will be described.

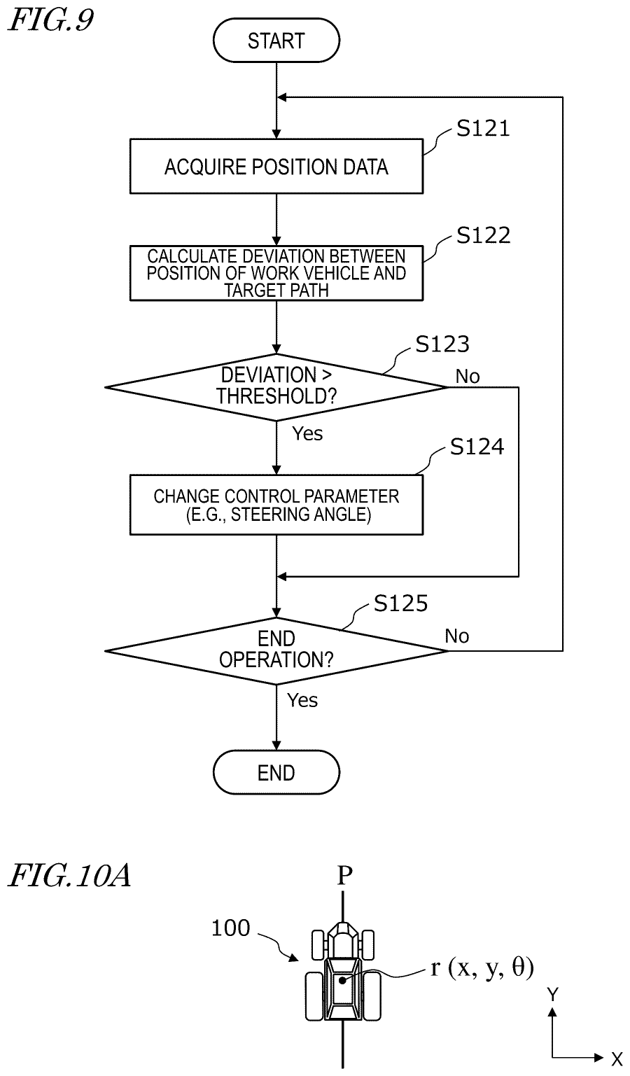

FIG. 9 is a flowchart showing an example operation of steering control to be performed by the controller 180 during self-driving. During travel of the agricultural machine 300, the controller 180 performs automatic steering by performing the operation from steps S121 to S125 shown in FIG. 9. The speed will be maintained at a previously-set speed, for example. First, during travel of the agricultural machine 300, the controller 180 acquires data representing the position of the agricultural machine 300 that is generated by the positioning device 130 (step S121). Next, the controller 180 calculates a deviation between the position of the agricultural machine 300 and the target path (step S122). The deviation represents the distance between the position of the agricultural machine 300 and the target path at that moment. The controller 180 determines whether the calculated deviation in position exceeds the previously-set threshold or not (step S123). If the deviation exceeds the threshold, the controller 180 changes a control parameter of the steering device included in the drive device 140 so as to reduce the deviation, thus changing the steering angle (step S124). If the deviation does not exceed the threshold at step S123, the operation of step S124 is omitted. At the following step S125, the controller 180 determines whether a command to end operation has been received or not. The command to end operation may be given when the user has instructed that self-driving be suspended through remote manipulations, or when the agricultural machine 300 has arrived at the destination, for example. If the command to end operation has not been issued, the control returns to step S121 and performs a similar operation based on a newly measured position of the agricultural machine 300. The controller 180 repeats the operation from steps S121 to S125 until a command to end operation is given. The aforementioned operation is executed by the ECUs 182 and 184 in the controller 180.

In the example shown in FIG. 9, the controller 180 controls the drive device 140 based only on a deviation between the position of the agricultural machine 300 as identified by the positioning device 130 and the target path. However, a deviation in terms of directions may further be considered in the control. For example, when a directional deviation exceeds a previously-set threshold, where the directional deviation is an angle difference between the orientation of the agricultural machine 300 as identified by the positioning device 130 and the direction of the target path, the controller 180 may change the control parameter (e.g., steering angle) of the steering device of the drive device 140 in accordance with the deviation.

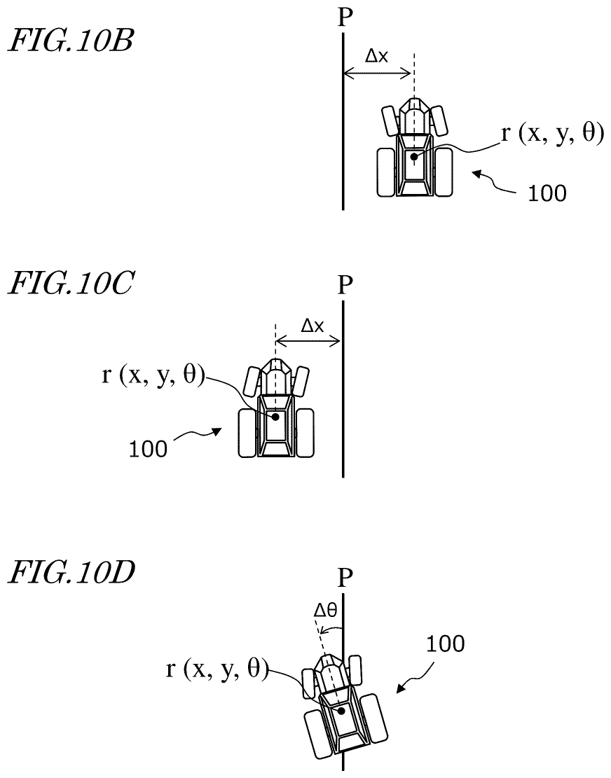

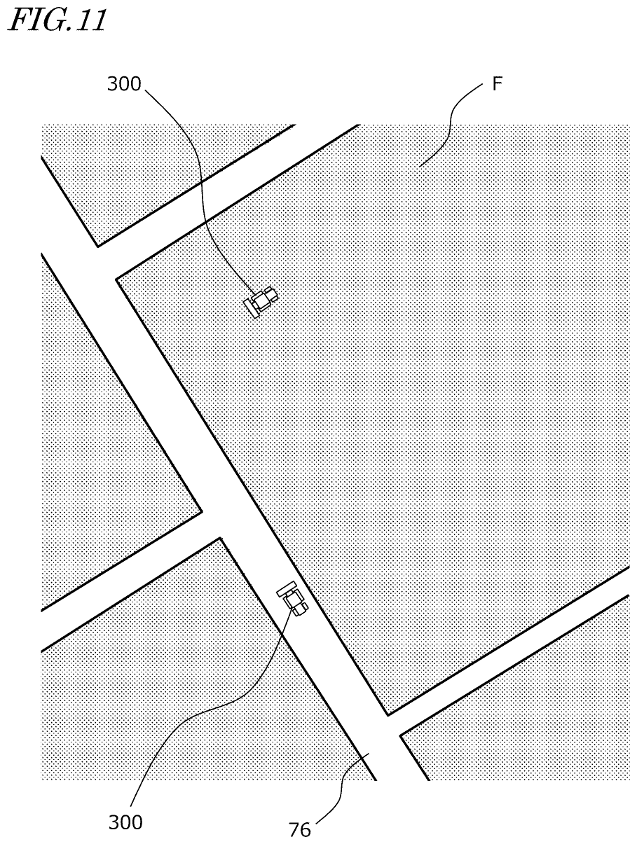

Hereinafter, with reference to FIGS. 10A to 10D, an example of steering control by the controller 180 will be described more specifically.

FIG. 10A is a diagram showing an example of an agricultural machine 300 that travels along a target path P. FIG. 10B is a diagram showing an example of an agricultural machine 300 at a position which is shifted rightward from the target path P. FIG. 10C is a diagram showing an example of an agricultural machine 300 at a position which is shifted leftward from the target path P. FIG. 10D is a diagram showing an example of an agricultural machine 300 which is oriented in an inclined direction with respect to the target path P. In these figures, the pose, i.e., the position and orientation, of the agricultural machine 300 as measured by the positioning device 130 is expressed as r (x,y,θ). Herein, (x,y) are coordinates representing the position of a reference point on the agricultural machine 300, in an XY coordinate system which is a two-dimensional coordinate system being fixed to the globe. In the examples shown in FIGS. 10A to 10D, the reference point on the agricultural machine 300 is at a position on the cabin where a GNSS antenna is located, but the reference point may be at any arbitrary position. θ is an angle representing the measured orientation of the agricultural machine 300. Although the target path P is shown parallel to the Y axis in the examples illustrated in these figures, generally speaking, the target path P may not necessarily be parallel to the Y axis.

As shown in FIG. 10A, in the case where the position and orientation of the agricultural machine 300 are not deviated from the target path P, the controller 180 maintains the steering angle and speed of the agricultural machine 300 without changing them.

As shown in FIG. 10B, when the position of the agricultural machine 300 is shifted rightward from the target path P, the controller 180 changes the steering angle so that the traveling direction of the agricultural machine 300 will be inclined leftward, thus bringing the agricultural machine 300 closer to the path P. Herein, not only the steering angle but also the speed may be changed. The magnitude of the steering angle may be adjusted in accordance with the magnitude of a positional deviation Δx, for example.

As shown in FIG. 10C, when the position of the agricultural machine 300 is shifted leftward from the target path P, the controller 180 changes the steering angle so that the traveling direction of the agricultural machine 300 will be inclined rightward, thus bringing the agricultural machine 300 closer to the path P. In this case, too, not only the steering angle but also the speed may be changed. The amount of change of the steering angle may be adjusted in accordance with the magnitude of the positional deviation Δx, for example.

As shown in FIG. 10D, in the case where the position of the agricultural machine 300 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the agricultural machine 300 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation Δθ in determining the steering angle.

For the steering control and speed control of the agricultural machine 300, control techniques such as PID control or MPC (Model Predictive Control) may be applied. Applying these control techniques will achieve smoothness of the control of bringing the agricultural machine 300 closer to the target path P.

Note that, when an obstacle is detected by one or more obstacle sensors 136 during travel, the controller 180 halts the agricultural machine 300. Alternatively, when an obstacle is detected, the controller 180 may control the drive device 140 so as to avoid the obstacle. The controller 180 may also detect objects (e.g., other vehicles, pedestrians, etc.) that are located at relatively distant positions from the agricultural machine 300, based on the sensor data which is output from the LiDAR sensor 156. By performing speed control and steering control so as to avoid the detected objects, the controller 180 achieves self-traveling on public roads.

In the present example embodiment, the agricultural machine 300 is able to automatically travel inside the field and outside the field in an unmanned manner. FIG. 11 is a diagram schematically showing an example situation where a plurality of agricultural machines 300 are self-traveling inside a field F and on a road 76 outside the field F. In the storage 170, an environment map of the inside of the field and the outside of the field including public roads and information of target paths is recorded. The environment map and target paths are generated by the ECU 185 of the controller 180, for example. When the agricultural machine 300 travels on a public road, the agricultural machine 300 travels along a target path while sensing the surroundings by using sensing devices such as the cameras 155 and the LiDAR sensor 156, with the implement 400 raised. During travel, the target path may be changed depending on the situation.

An agricultural machine 300 according to the present example embodiment automatically performs movement between fields and the agricultural task for each field, in accordance with a task schedule that is recorded in a storage that is mounted on the agricultural machine 300. The task schedule includes information on a plurality of agricultural tasks to be performed over a number of work days. Specifically, the task schedule may be a database that includes information indicating which agricultural task is to be performed by which agricultural machine at which point of time and in which field for each work day. Based on information that is input by the user by using the terminal apparatus 200, the task schedule may be generated by the processor 21 of the server 100. Hereinafter, an example method of generating the task schedule will be described.

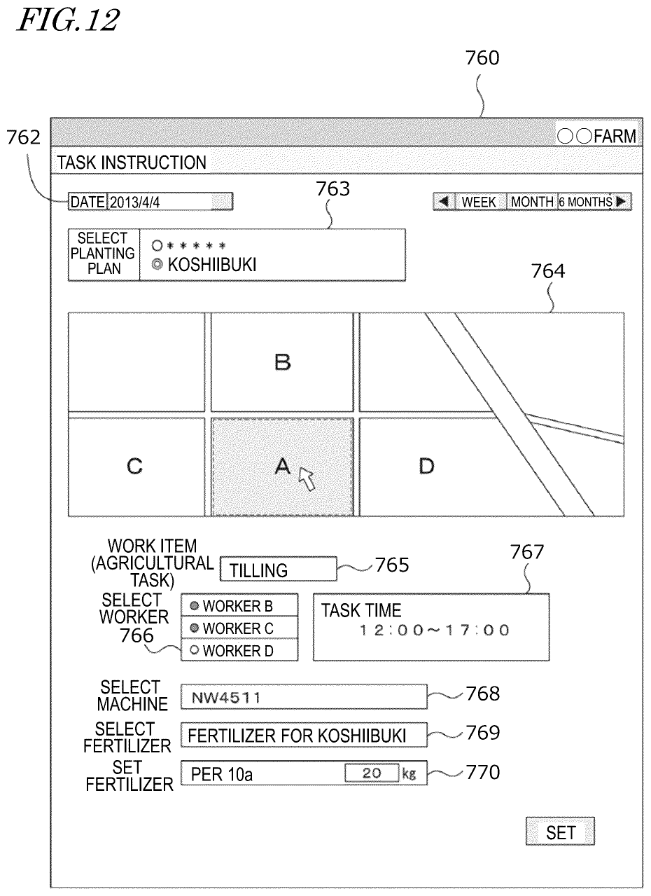

FIG. 12 is a diagram showing an example of a setting screen 760 that is displayed on the display device 220 of the terminal apparatus 200. In accordance with the user's manipulation by using the input device 210, the processor 230 of the terminal apparatus 200 activates an application for schedule generation to cause the setting screen 760 as shown in FIG. 12 on the display device 220. On this setting screen 760, the user is able to input information that is necessary for generating the task schedule.

FIG. 12 shows an example of the setting screen 760 in a case where tilling, including spreading of a fertilizer, is performed as an agricultural task in a field for rice cultivation. Without being limited to what is illustrated in the figure, the setting screen 760 may be modified as appropriate. The setting screen 760 in the example of FIG. 12 includes a date setting section 762, a planting plan selecting section 763, a field selecting section 764, a task selecting section 765, a worker selecting section 766, a time setting section 767, a machine selecting section 768, a fertilizer selecting section 769, and an application amount setting section 770.

In the date setting section 762, a date that has been input with the input device 210 is displayed. The input date is set as a date for performing the agricultural task.

In the planting plan selecting section 763, a list of names of planting plans that was previously created is displayed. The user can select a desired planting plan from this list. The planting plan is previously generated for each kind or cultivar of crop, and recorded in the storage 30 of the server 100. The planting plan is a plan as to which crop is to be planted in which field. The planting plan is made by an administrator who manages the plurality of fields, etc., prior to planting a crop in a field. The field is a partitioned agricultural field in which crops are to be planted (i.e., grown). In the example of FIG. 4, a planting plan for “Koshiibuki”, which is a cultivar of rice plant, is selected. In this case, the content to be set on the setting screen 760 is associated with the planting plan for “Koshiibuki”.

In the field selecting section 764, fields in the environment map are displayed. The user can select any field from among the displayed fields. In the example of FIG. 12, a portion indicating “field A” is selected. In this case, the selected “field A” is set as the field in which an agricultural task is to be performed.

In the task selecting section 765, a plurality of agricultural tasks that are needed in order to cultivate the selected crop are displayed. The user can select one of the plurality of agricultural tasks. In the example of FIG. 12, “tilling” is selected from among the plurality of agricultural tasks. In this case, the selected “tilling” is set as the agricultural task to be performed.

In the worker selecting section 766, previously-registered workers are displayed. The user can select one or more workers from among the plurality of displayed workers. In the example of FIG. 12, from among the plurality of workers, “worker B, worker C” are selected. In this case, the selected “worker B, worker C” are set as the workers to perform or manage the given agricultural task. In the present example embodiment, because the agricultural machine automatically performs the agricultural task, the worker may not actually perform the agricultural task, but only remotely monitor the agricultural task being performed by the agricultural machine.

In the time setting section 767, a task time that is input via the input device 210 is displayed. The task time is designated by a start time and an end time. The input task time is set as a scheduled time at which the agricultural task is to be performed.

The machine selecting section 768 is usable to set the agricultural machine to be used for the given agricultural task. In the machine selecting section 768, for example, the IDs (identification information) and types or models of the agricultural machines which have been previously registered by the server 100, types or models of usable implements, etc., may be displayed. The user can select a specific machine from among the indicated machines. In the example of FIG. 12, an implement model “NW4511” is selected. In this case, this implement is set as the machine to be used for the given agricultural task.

In the fertilizer selecting section 769, names of a plurality of fertilizers which have been previously registered by the server 100 may be displayed. The user can select a specific fertilizer from among the indicated plurality of fertilizers. The selected fertilizer is set as the fertilizer to be used for the given agricultural task.

In the application amount setting section 770, a numerical value that is input via the input device 210 is displayed. The input numerical value is set as an application amount.

Once a planting plan, a field, an agricultural task, a worker, a task time, a fertilizer, and an application amount are input in the setting screen 760 and “SET” is selected, the communicator 270 of the terminal apparatus 200 transmits the input information to the server 100. The processor 21 of the server 100 stores the received information to the storage 30. Based on the received information, the processor 21 generates a schedule of agricultural tasks to be performed by each agricultural machine, and stores it to the storage 30.

Note that the information of agricultural tasks to be managed by the server 100 is not limited to what is described above. For example, an ability to set the kind and application amount of an agrochemical to be used for the field on the setting screen 760 may be provided. An ability to set information on agricultural tasks other than the agricultural task shown in FIG. 12 may be provided.

FIG. 13 is a diagram showing an example of a schedule of agricultural tasks to be generated by the server 100. The schedule in this example includes, for each registered agricultural machine, information indicating the date and time at which the agricultural task is to be performed, the field, the content of work, and the implement used. Other than the information shown in FIG. 13, depending on the content of work, the schedule may contain information on an agrochemical or the application amount of an agrochemical, etc., for example. In accordance with such a schedule, the processor 21 of the server 100 instructs the agricultural machine 300 as to an agricultural task. The schedule is downloaded by the controller of the agricultural machine 300, and may be stored also to the storage of the agricultural machine 300. In that case, the controller of the agricultural machine 300 may spontaneously begin operation in accordance with the schedule stored in the storage.

A plurality of agricultural machines 300 according to the present example embodiment have non-overlapping and unique agricultural machine IDs and priority levels given thereto. For each agricultural machine, the priority level according to the present example embodiment is assigned in accordance with the kind of agricultural task to be performed by the agricultural machine. Hereinafter, a priority level that is assigned to each agricultural machine may be referred to as “the priority level of the agricultural machine”. Unlike the agricultural machine IDs, the priority levels may overlap among the plurality of agricultural machines. The kind of agricultural task may also be expressed as an item of agricultural work. Example kinds of agricultural tasks include, in the case of rice cultivation: bed soil preparation, furrow coating, tilling, seeding, rice planting, soil puddling, mowing, ditching, weeding, manure spreading, harvesting, etc., and in the case of field cropping, ridge making, settled planting, weeding, intertillage ridging, harvesting, etc.

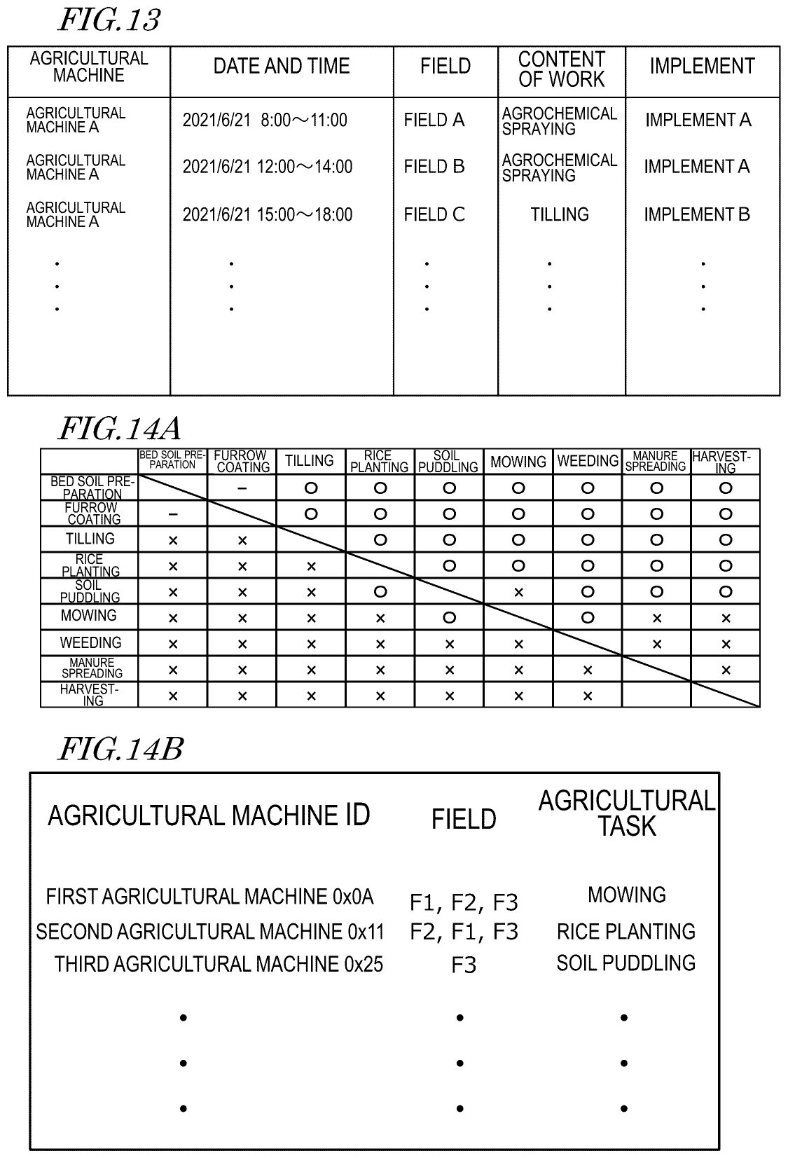

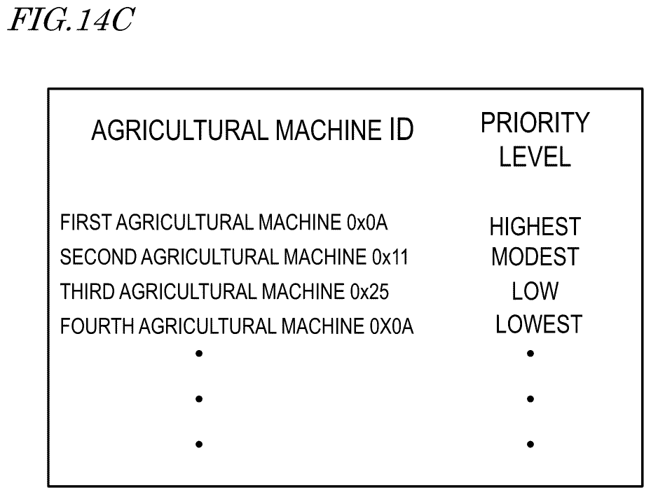

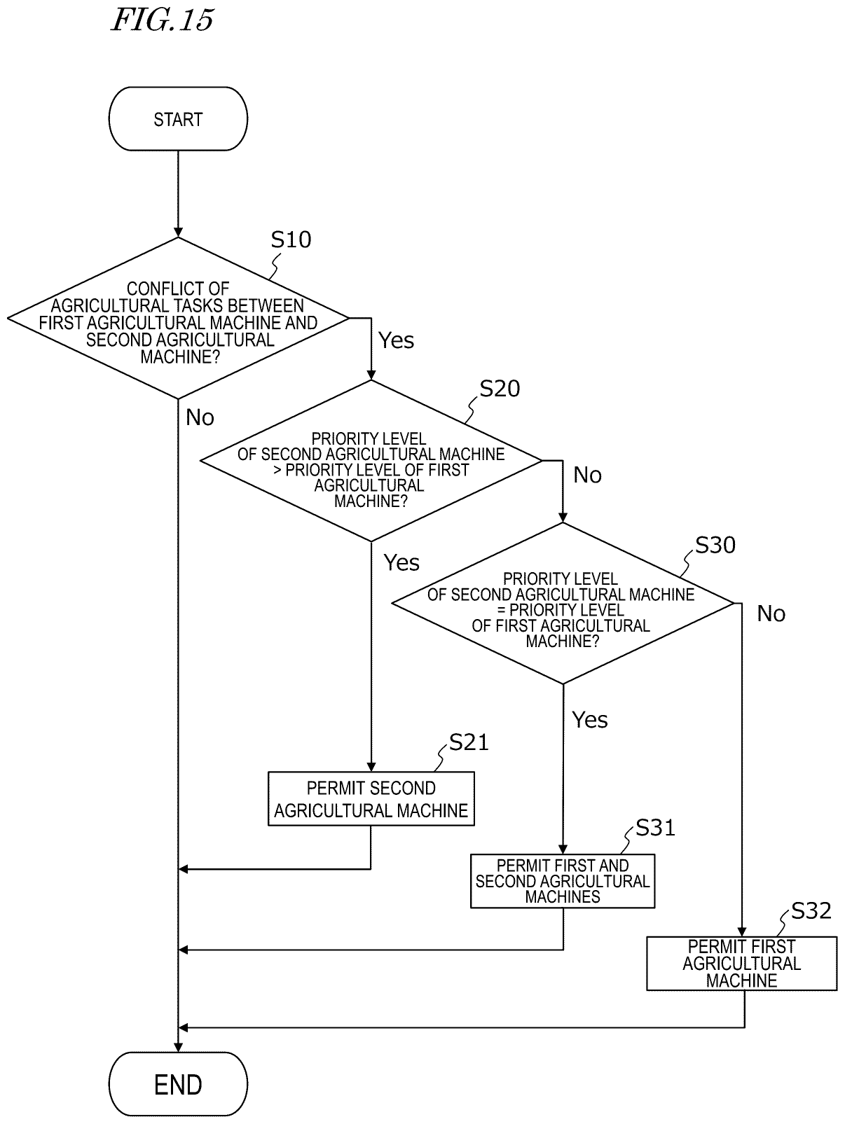

FIG. 14A is a diagram showing an example relationship between agricultural tasks and priority levels. In FIG. 14A, “∘” means that an agricultural task indicated in a row item has a higher priority level than the priority level of an agricultural task indicated in a column item. “x” indicates that an agricultural task indicated in a row item has a lower priority level than the priority level of an agricultural task indicated in a column item. “-” means that the priority level of an agricultural task indicated in a row item is equal to the priority level of an agricultural task indicated in a column item. In the illustrated relationship, for example, the priority level of bed soil preparation is equal to the priority level of furrow coating, and higher than the priority levels of the rest, i.e., tilling, rice planting, soil puddling, mowing, weeding, manure spreading, harvesting. The priority level of tilling is lower than the priority levels of bed soil preparation and furrow coating, but is higher than the priority levels of rice planting, soil puddling, mowing, weeding, manure spreading, and harvesting. Without being limited to the illustrated example, for example, the administrator may determine or change the relationship between agricultural tasks and priority levels as appropriate. By using the terminal apparatus 200, the administrator can transmit information of the determined or changed relationship between agricultural tasks and priority levels to the server 100. At the server 100, a table that associates a relationship between agricultural tasks and priority levels is generated, and stored to the storage 30.

FIG. 14B is a diagram showing another example of a schedule of agricultural tasks that is generated by the server 100. A schedule of agricultural tasks according to the present example embodiment includes information of agricultural machine IDs for identifying agricultural machines. As described above, the user can use the terminal apparatus 200 to associate agricultural machine IDs with the task schedule. FIG. 14B shows an example of a table that associates, for each agricultural machine 300, an agricultural machine ID, a field to be worked on for the day, and the content of work. This table is stored to the storage 30, for example. In the exemplary table, the first agricultural machine (ID: 0x0A) is scheduled to perform the mowing task in the order of fields F1, F2 and F3. The second agricultural machine (ID: 0x11) is scheduled to perform the rice planting task in the order of fields F2, F1 and F3. The third agricultural machine (ID: 0x25) is scheduled to perform the soil puddling task in field F3. Note that 0× signifies a hexadecimal notation.

FIG. 14C is a diagram showing an example of a table that associates agricultural machine IDs and the priority levels of agricultural machines. In the aforementioned example, relative priority levels are determined based on the content of the agricultural task; however, it may be possible to assign one of the five priority levels of “HIGHEST”, “HIGH”, “MODEST”, “LOW”, “LOWEST” to each agricultural machine 300 in accordance with the content of its agricultural task, for example. In the illustrated exemplary table, “HIGHEST” is assigned to the first agricultural machine; “MODEST” is assigned to the second agricultural machine; “LOW” is assigned to the third agricultural machine; and “LOWEST” is assigned to the fourth agricultural machine.

While referring to the table mapping the relationship between agricultural tasks and priority levels, in accordance with the task schedule, the processing unit 20 of the server 100 according to the present example embodiment may determine a field in which the agricultural machine 300 is to perform an agricultural task next, instruct the agricultural machine 300 to move to the determined field, or cause the agricultural machine working in the field to stop its task and instruct it to exit the field, thereby managing access to the field. Under the management of access to the field by the processing unit 20, the controller 180 of the agricultural machine 300 realizes self-traveling of the agricultural machine 300.

A method of managing access to a field according to the present example embodiment is implemented in the processing unit 20 of the server 100. FIG. 15 is a flowchart illustrating the procedure of the method of managing access to a field. While the first agricultural machine 300A is performing a task in field F1, if a conflict of tasks for field F1 exists between the first agricultural machine 300A and the second agricultural machine 300B (step S10), the processing unit 20 allows at least one of the first agricultural machine 300A and the second agricultural machine 300B that is determined based on priority data to perform the task for field F1.

If the priority level of the second agricultural machine 300B is higher than the priority level of the first agricultural machine 300A (Yes from step S20), the processing unit 20 allows its second agricultural machine 300B to perform the agricultural task for field F1 (step S21). If the priority level of the second agricultural machine 300B is not higher than the priority level of the first agricultural machine 300A (No from step S20) and the priority level of the second agricultural machine 300B and the priority level of the first agricultural machine 300A are equal (Yes from step S30), the processing unit 20 allows the first agricultural machine 300A and the second agricultural machine 300B to perform their agricultural tasks for field F1 (step S31). If the priority level of the second agricultural machine 300B is lower than the priority level of the first agricultural machine 300A (No from step S30), the processing unit 20 allows the first agricultural machine 300A to perform its agricultural task for field F1 (step S32).

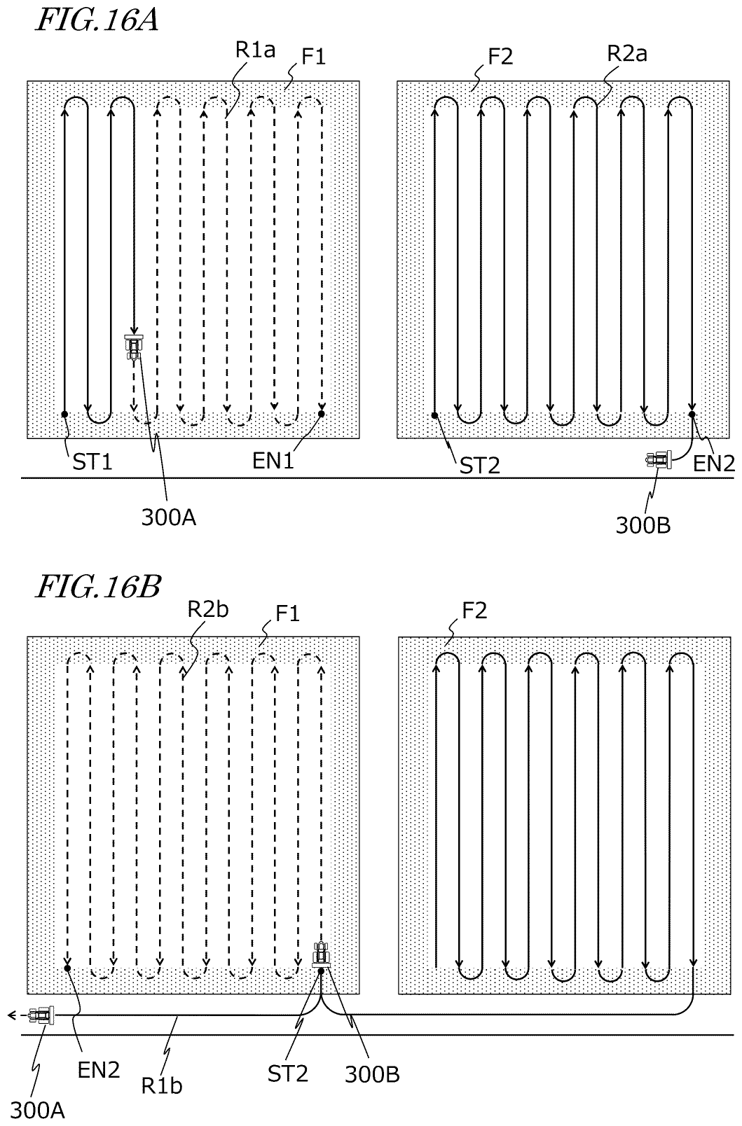

Next, with reference to FIGS. 16A to 19C, an example operation of the server 100 (mainly the processing unit 20) and the agricultural machine 300 will be described. A plurality of agricultural machines 300 that are connected to the management system 1000 described below include a first agricultural machine 300A and a second agricultural machine 300B. However, the plurality of agricultural machines 300 may include three or more agricultural machines.

The first agricultural machine 300A and the second agricultural machine 300B according to the present example embodiment travel via self-driving on a road from a storage location to the field or a road from the field to another field, and also automatically perform tasks within the field, for example. Note that the first agricultural machine 300A and the second agricultural machine 300B may move via manual driving from the field to another field in which to perform work next, and perform their work in the field via manual operation of the driver. The storage location may be a barn at the owner's home of the agricultural machines, or a garage of an office of the farm manager, for example. The agricultural machines may be stored in a locked storage location.

In the case where the first agricultural machine 300A and the second agricultural machine 300B each perform self-driving, a target path for moving between the fields and/or a target path for performing agricultural work while moving within the field may be generated manually or automatically before self-driving is begun. Once the target path is determined, the first agricultural machine 300A and the second agricultural machine 300B each automatically travel along the target path. In the case where the agricultural machine 300 travels along a public road, the agricultural machine 300 may travel along the target path while sensing the surroundings by using sensing devices such as the cameras and the LiDAR sensor, with the implement raised.

FIGS. 16A and 16B are diagrams for describing a method of managing access to a field F1 according to a first example. FIG. 16A illustrates a state in which the second agricultural machine 300B has finished its task for a field F2 according to the task schedule shown in FIG. 14B and is standing by for access to the field F1. A target path R1a in the field F1 of the first agricultural machine 300A is shown with broken-line arrows, whereas a target path that has already been traveled is indicated by solid lines. A target path R2a within the field F2 for the second agricultural machine 300B having finished its task is indicated by solid-line arrows. The target path R1a includes a start point ST1 of beginning work, an end point EN1 of ending work, and traveling directions as indicated by arrows in the figure. Similarly, the target path R2a includes a start point ST2 of beginning work, an end point EN2 of ending work, and traveling directions as indicated by arrows in the figure. FIG. 16B illustrates a state in which the first agricultural machine 300A has exited the field F1, and in which the second agricultural machine 300B which has been permitted access to the field F1 has moved to the field F1 to begin work. Although the figures illustrate two adjacent fields F1 and F2 for simplicity, the fields F1 and F2 may be located at places which are physically remote but which allow the agricultural machines to move.

By referring to the table mapping the relationship between agricultural tasks and priority levels and the schedule of agricultural tasks, the processing unit 20 compares between the priority level of the first agricultural machine 300A and the priority level of the second agricultural machine 300B. If the priority level of the second agricultural machine 300B is higher than the priority level of the first agricultural machine 300A, the processing unit 20 allows the second agricultural machine 300B to perform the task for the field F1 with priority over the first agricultural machine 300A. According to the task schedule illustrated in FIG. 14B, the first agricultural machine 300A is performing a mowing task in the field F1. In the meantime, the second agricultural machine 300B may have finished the rice planting task for the field F2 earlier than is scheduled and moved to the next field F1, and be beginning to perform a rice planting task. As a result of this, a conflict of tasks for the field F1 occurs between the first agricultural machine 300A and the second agricultural machine 300B. In this case, by referring to the table mapping the relationship between agricultural tasks and priority levels as illustrated in FIG. 14A, the processing unit 20 determines that the priority level of the rice planting task of the second agricultural machine 300B is higher than the priority level of mowing of the first agricultural machine 300A. Because the priority level of the second agricultural machine 300B is higher than the priority level of the first agricultural machine 300A, the processing unit 20 causes the first agricultural machine 300A to stop the task for the field F1, and instead allows the second agricultural machine 300B to perform the task for the field F1. When causing the first agricultural machine 300A to stop the task for the field F1, the processing unit 20 may further cause the first agricultural machine 300A to exit the field F1. If the priority level of the second agricultural machine 300B is lower than the priority level of the first agricultural machine, the processing unit 20 does not permit the second agricultural machine 300B to perform its task for the field F1. The first agricultural machine 300A can continue its task for the field F1.

In one example, when permitting the second agricultural machine 300B access to the field F1, the processing unit 20 may transmit positional information of the field F1 to the controller 180 of the second agricultural machine 300B. Based on the received positional information of the field F1, the controller 180 of the second agricultural machine 300B may generate a target path from the field F2 to the field F1 and a target path for allowing the second agricultural machine 300B to perform an agricultural task in the field F1. This allows the second agricultural machine 300B to travel or move along the target path. Moreover, when causing the first agricultural machine 300A to exit the field F1, the processing unit 20 may update the schedule of tasks to be performed by the first agricultural machine 300A, or generate a target path for the first agricultural machine 300A to move to the next destination. In FIG. 16B, a target path R2b for the second agricultural machine 300B to perform work in the field F1 is shown by broken-line arrows, whereas a target path Rib for the first agricultural machine 300A to move to the next destination via self-driving is shown by broken-line arrows.

As shown in FIG. 16A, before a conflict of tasks for the field F1 occurs between the first agricultural machine 300A and the second agricultural machine 300B, the target path R1a of the first agricultural machine 300A is set in the field F1. On the other hand, as shown in FIG. 16B, after the processing unit 20 has permitted the second agricultural machine 300B access to the field F1, the target path R2b of the second agricultural machine 300B is set in the field F1. The controller 180 of the second agricultural machine 300B may acquire the target path R1a of the first agricultural machine 300A via the server 100. The controller 180 of the second agricultural machine 300B may generate the target path R2b by utilizing the target path R1a. For example, the controller 180 of the second agricultural machine 300B may generate the target path R2b by: setting the end point EN2 of the target path R1a as the start point ST2 of the target path R2b; setting the start point ST1 of the target path R1a as the end point EN2 of the target path R2b; and reversing the traveling direction. Moreover, when the processing unit 20 causes the first agricultural machine 300A to exit the field, the controller 180 of the first agricultural machine 300A may change the target path R1a to the target path R1b.

The processing unit 20 according to an aspect of an example embodiment of the present disclosure performs centralized management of the schedule of tasks to be respectively performed by the plurality of agricultural machines 300, and monitors the progress of work of each agricultural machine 300. From the progress of work of the second agricultural machine 300B, the processing unit 20 can determine whether the second agricultural machine 300B has finished its task for the field F2 or not. Based on the aforementioned task schedule, the processing unit 20 determines the next field for the second agricultural machine 300B to work. If the processing unit 20 tries to allow the second agricultural machine 300B to work in the field F1 while the first agricultural machine 300A is performing work in the field F1, a conflict of tasks for the field F1 occurs between the first agricultural machine 300A and the second agricultural machine 300B. In that case, while referring to the table mapping the relationship between agricultural tasks and priority levels, the processing unit 20 can determine the agricultural machine to work in the field F1 based on its priority level.

The processing unit 20 according to another aspect of an example embodiment of the present disclosure functions as an arbitration circuit to perform an arbitration process in response to a request from each agricultural machine 300. When performing an agricultural task via self-driving, the agricultural machine 300 may generate log data including information such as a start point and an end point of the agricultural task for the field and a trajectory that is obtained by actually moving along the target path. Based on the generated log data, the agricultural machine 300 can autonomously determine whether the task for the field has been finished or not. For example, upon autonomously determining that the task for the field F2 has been finished, the second agricultural machine 300B may notify the processing unit 20 of the completion of the agricultural task. This notification serves as a request for the processing unit 20 to determine a next field for the agricultural machine 300 to work according to the task schedule. When a conflict of agricultural tasks for the field exists between two or more agricultural machines 300, the processing unit 20 may determine an agricultural machine to work in the field by referring to the table mapping the relationship between agricultural tasks and priority levels.

After the task for the other field F2, which is distinct from the field F1, the second agricultural machine 300B may transmit a notification of completion of the task or a request to the processing unit 20, for example. However, the second agricultural machine 300B may transmit a request for agricultural work for the field to the processing unit 20 from a place that is distinct from the field, e.g., a storage location of the farmer.

The method of managing access to a field according to the present example embodiment is applicable not only to an agricultural machine that moves via self-driving, but also to an agricultural machine that moves via manual driving. For example, when an agricultural worker is manually manipulating an agricultural machine to perform an agricultural task, the processing unit 20 may follow the method of managing according to the present example embodiment to determine a field in which the agricultural machine is to perform an agricultural task next, in response to a notification of completion of the task from the operational terminal 153 or terminal apparatus 200 used by that agricultural worker. The processing unit 20 may transmit positional information of the determined field to the operational terminal 153 or the terminal apparatus 200 used by the agricultural worker, cause it to be displayed on the display of the operational terminal 153 or the terminal apparatus 200, and urge the agricultural worker to move to the determined field.

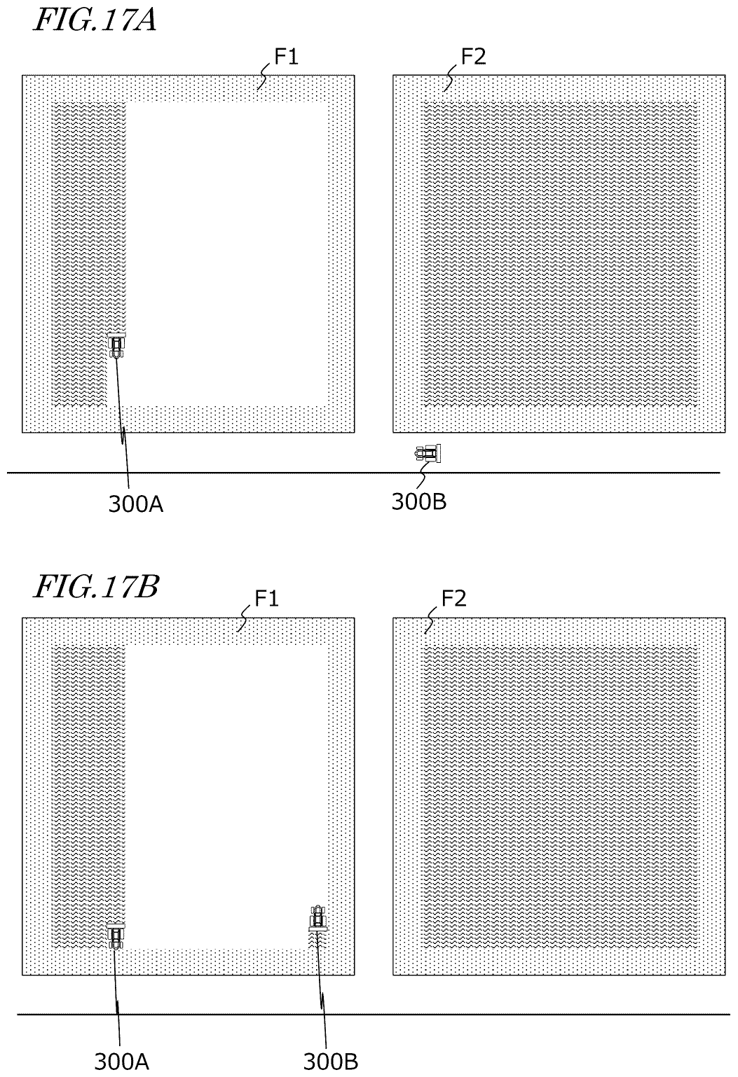

FIGS. 17A and 17B are diagrams for describing a method of managing access to the field F1 according to a second example. FIG. 17A illustrates a state in which the second agricultural machine 300B has finished its task for the field F2 and is standing by for access to the field F1. FIG. 17B illustrates a state in which the second agricultural machine 300B having been permitted access to the field F1 has moved to the field F1 to begin work.

When the first agricultural machine 300A is performing a task in the field F1, a conflict of tasks for the field F1 may occur between the first agricultural machine 300A and the second agricultural machine 300B. By referring to the table mapping the relationship between agricultural tasks and priority levels, the processing unit 20 compares between the priority level of the first agricultural machine 300A and the priority level of the second agricultural machine 300B. If the priority level of the first agricultural machine 300A and the priority level of the second agricultural machine 300B are equal, the processing unit 20 allows the first agricultural machine 300A to continue its task for the field F1, and allows the second agricultural machine 300B to perform its task for the field F1. In the example shown in FIG. 14A, the priority levels of bed soil preparation and furrow coating are equal. Through orchestrated work of the first agricultural machine 300A and the second agricultural machine 300B, tasks for the field F1 can be accelerated.

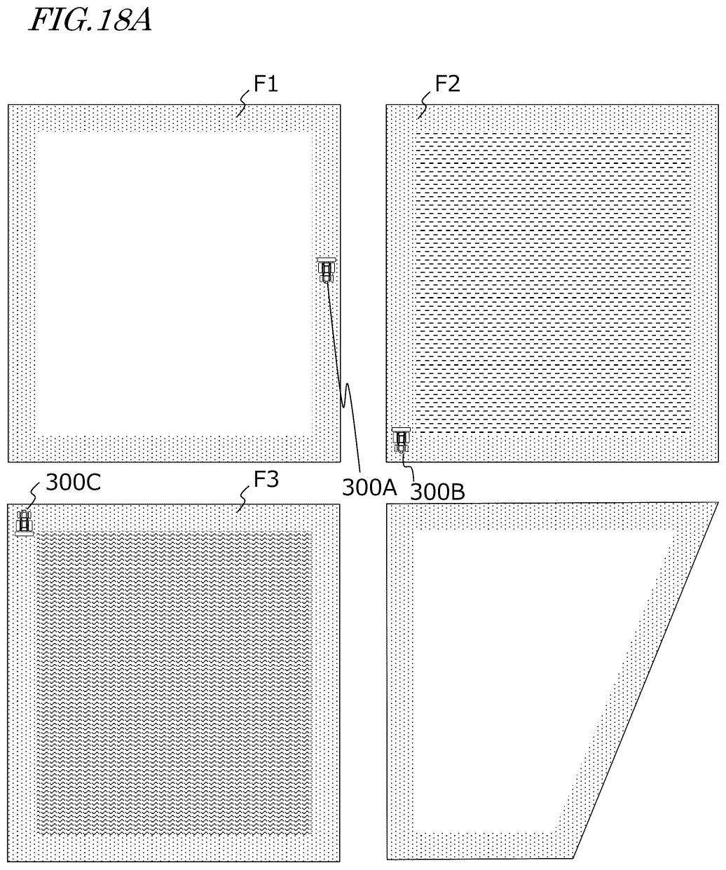

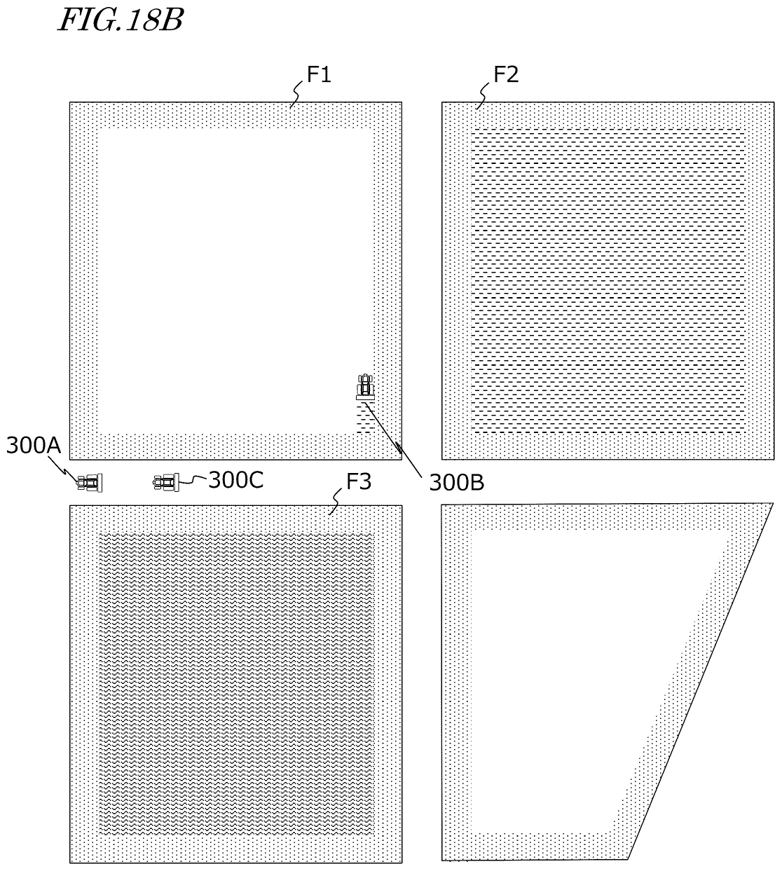

The plurality of agricultural machines 300 may further include a third agricultural machine 300C. FIGS. 18A and 18B are diagrams for describing a method of managing access to the field F1 according to a third example. FIG. 18A illustrates a state in which the second agricultural machine 300B and the third agricultural machine 300C have finished their tasks and are standing by for access to the field F1. FIG. 18B illustrates a state in which the second agricultural machine 300B having been permitted access to the field F1 has moved to the field F1 to begin work.

As illustrated in FIG. 18A, after the second agricultural machine 300B has finished its task for the field F2 and the third agricultural machine 300C has finished its task for the field F3, a conflict of agricultural tasks for the field F1 may occur between the first agricultural machine 300A, the second agricultural machine 300B, and the third agricultural machine 300C. Assuming that the priority level of the second agricultural machine 300B is the highest among the three agricultural machines, as illustrated in FIG. 18B, the processing unit 20 first causes the first agricultural machine 300A to exit the field F1, and thereafter allows the second agricultural machine 300B to move from the field F2 to the field F1 and begin its agricultural task for the field F1. The processing unit 20 does not permit the third agricultural machine 300C the agricultural task for the field F1. Instead, the processing unit 20 may cause the third agricultural machine 300C to move to another field distinct from the fields F1 and F2 and perform an agricultural task in the field.

The management system 1000 according to the present example embodiment may manage access of four or more agricultural machines to a field. In this case, too, if a conflict of access to the field exists between the four or more agricultural machines, the processing unit 20 may allow the agricultural machine of the highest priority level among the four or more agricultural machines to perform its agricultural task for the field with priority.

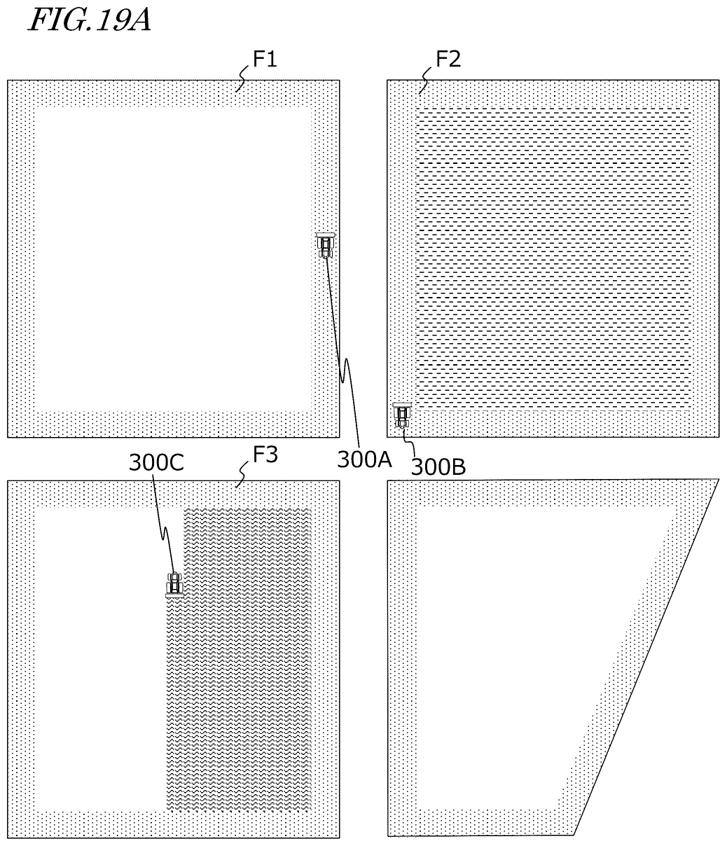

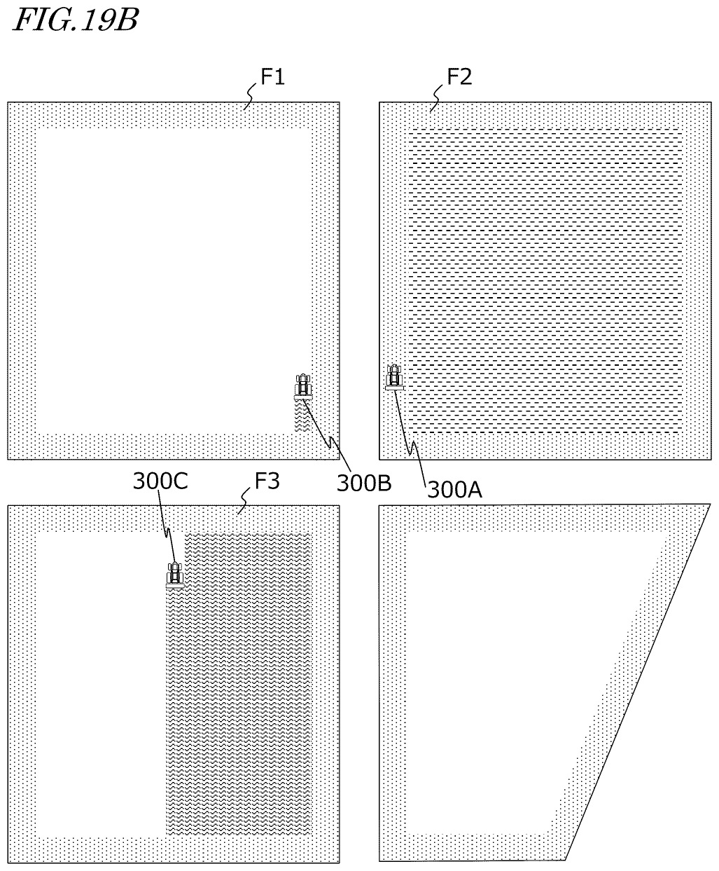

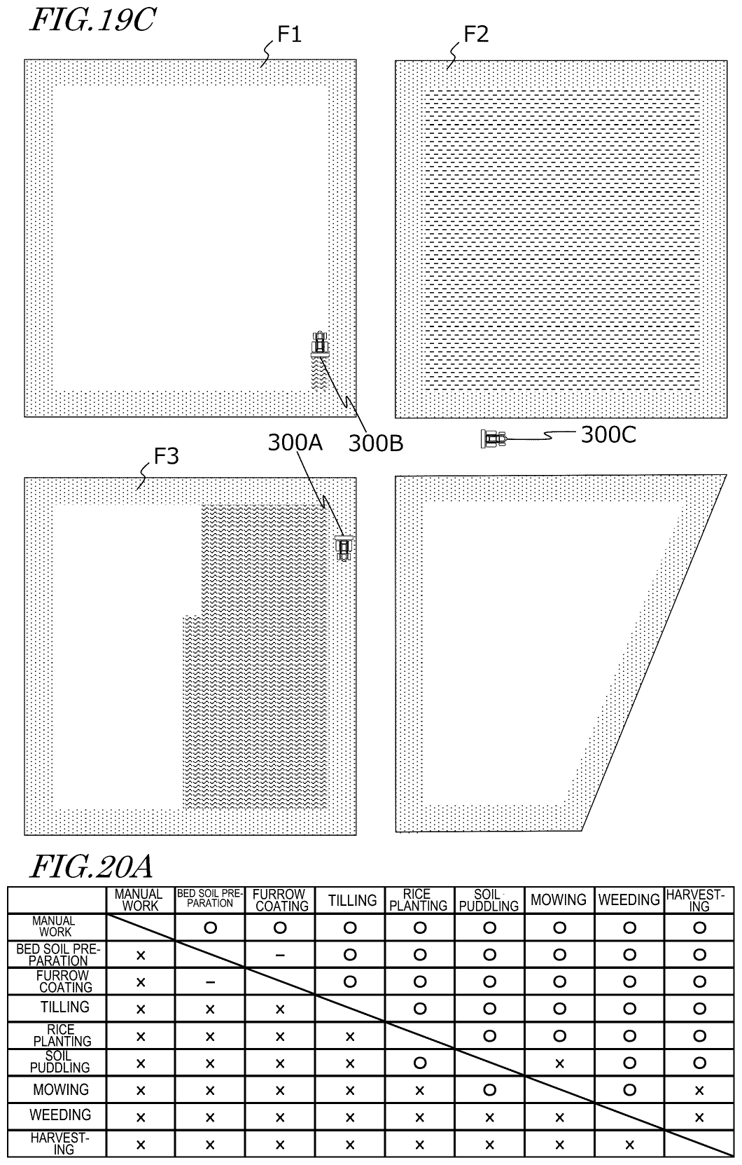

FIGS. 19A to 19C are diagrams for describing a method of managing access to the field F1 according to a fourth example. In the illustrated example, it is assumed that: the first agricultural machine 300A is performing a mowing task in the field F1; the second agricultural machine 300B is performing a rice planting task in the field F2; and the third agricultural machine 300C is performing a soil puddling task in the field F3.

The task schedule illustrated in FIG. 14B will be considered. For example, while the first agricultural machine 300A is performing the mowing task in the field F1, the second agricultural machine 300B may finish the rice planting task earlier than is scheduled in the field F2 and transmit a notification of completion of the task to the processing unit 20. Upon receiving the notification of completion of the task from the second agricultural machine 300B, the processing unit 20 permits the second agricultural machine 300B (as has been determined by referring to the table mapping the relationship between agricultural tasks and priority levels) the rice planting task for the field F1. The processing unit 20 causes the first agricultural machine 300A to stop its mowing task for the field F1 and exit the field F1. Thereafter, the processing unit 20 causes the second agricultural machine 300B to move from the field F2 to F1, and allows it to perform the rice planting task in the field F1.

As illustrated in FIG. 19B, the processing unit 20 may cause the first agricultural machine 300A to move from the field F1 to the vacant field F2 after being exited by the second agricultural machine 300B, and allow it to perform the mowing task in the field F2. In this case, because there is no conflict of access to the field F3, the processing unit 20 may allow the third agricultural machine 300C to continue the soil puddling task in the field F3.

In another example, the first agricultural machine 300A may be scheduled to perform the mowing task in the field F3, next to the field F1. In that case, if the processing unit 20 causes the first agricultural machine 300A to move from the field F1 to the field F3 and allows it to perform its agricultural task, a conflict of access to the field F3 will occur between the first agricultural machine 300A and the third agricultural machine 300C performing its soil puddling task in the field F3. As illustrated in FIG. 19C, the processing unit 20 permits the first agricultural machine 300A (as has been determined by referring to the table mapping the relationship between agricultural tasks and priority levels) the mowing task for the field F3. The processing unit 20 causes the third agricultural machine 300C to stop its soil puddling task for the field F3 and exit the field F3. Thereafter, the processing unit 20 causes the first agricultural machine 300A to move from the field F1 to the field F3, and allows it to perform the mowing task in the field F3. The processing unit 20 may cause the third agricultural machine 300C to move from the field F3 to another field.

With the method of managing access to a field according to the present example embodiment, while a plurality of agricultural machines are at work, even if a conflict of agricultural tasks for the field exists between two or more agricultural machines, the agricultural work as a whole can be efficiently promoted, without postponing tasks of high priority levels.

The management system 1000 according to the present example embodiment is able to manage access to a field between an agricultural machine and an agricultural worker. While an agricultural worker is performing an agricultural task in a field, if a conflict of agricultural tasks for the field exists between the agricultural machine 300 and the agricultural worker, the processing unit 20 can decide to allow the agricultural worker to continue his or her agricultural task for the field with priority over the agricultural machine 300, based on priority data, i.e., by referring to the table.

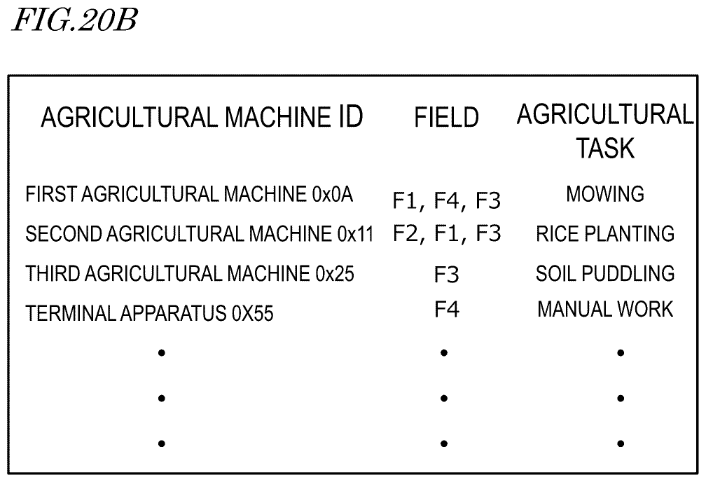

FIG. 20A is a diagram showing an example relationship between agricultural tasks including manual work by an agricultural worker and priority levels. FIG. 20B is a diagram showing an example of a schedule of agricultural tasks that is generated by the server 100. In the table shown in FIG. 20A, the priority level of manual work by an agricultural worker is set to be higher than the priority level of any other agricultural task. The items for selection to be displayed in the task selecting section 765 of the setting screen 760 illustrated in FIG. 12 may include a manual work item by an agricultural worker. For example, when an agricultural worker is expected to perform manual work in the field, the administrator may select the manual work item from among the plurality of agricultural tasks.

The task schedule shown in FIG. 20B associates identification information (terminal apparatus ID: 0x55) of the terminal apparatuses 200 to be used by an agricultural worker, fields, and agricultural tasks. As a result, a task schedule that includes not only agricultural machine tasks but also a schedule item of manual work by an agricultural worker is managed at the server 100. By referring to the table that associates agricultural tasks and priority levels, the processing unit 20 can assign a high priority level to an agricultural worker performing manual work. Assigning a priority level to an agricultural worker corresponds, in effect, to assigning a priority level to the terminal apparatus 200 that is used by the agricultural worker.

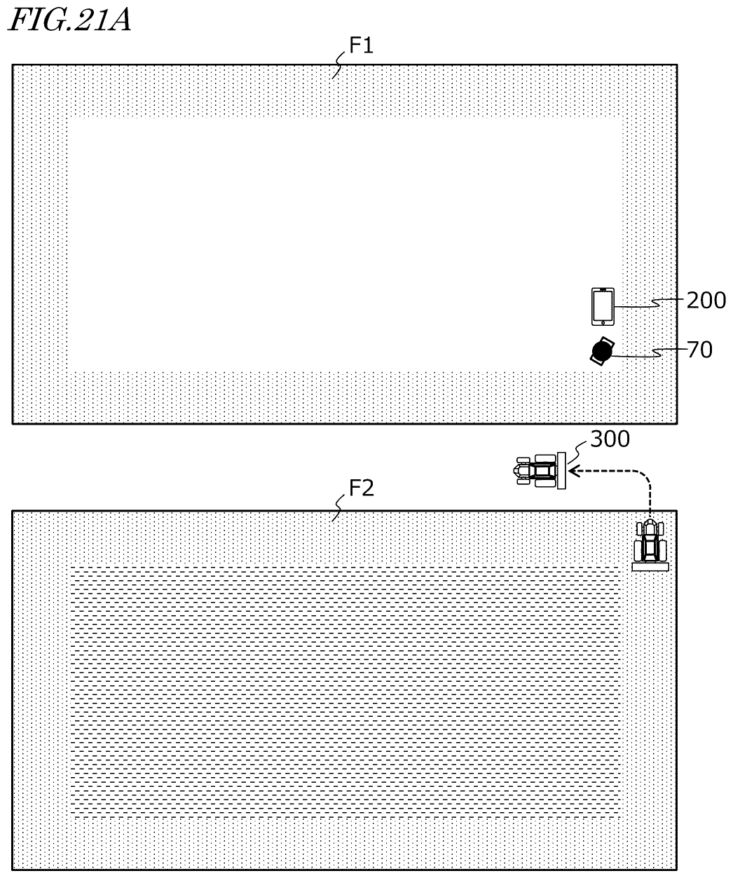

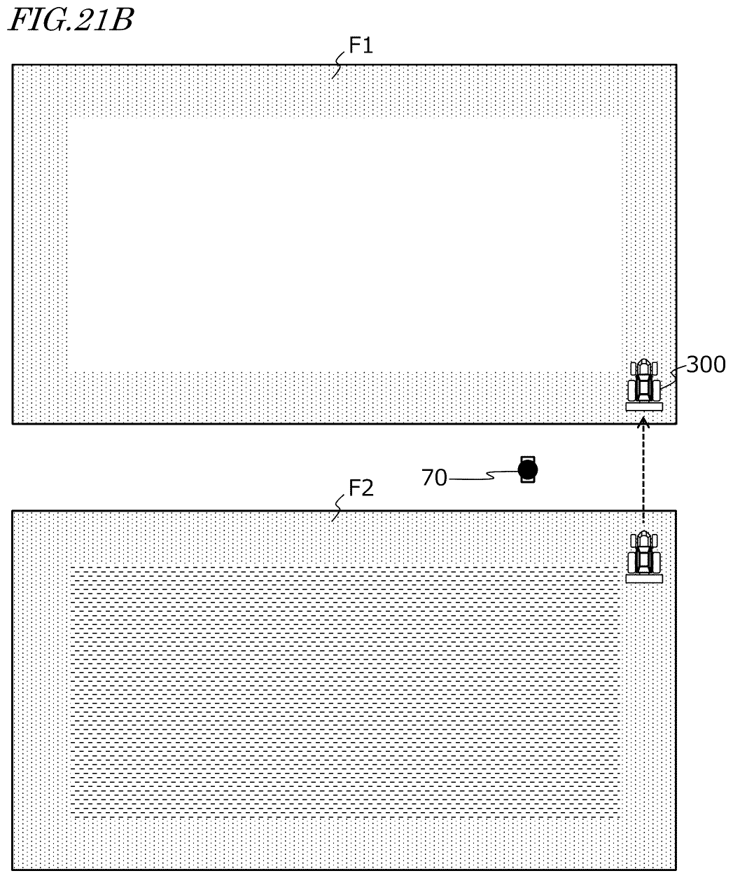

FIG. 21A is a diagram schematically showing a state in which an agricultural worker 70 is performing an agricultural task in the field F1. In the field F1 having been mowed by the agricultural machine 300, the agricultural worker 70 may be performing a task of mowing the remaining harvest in a corner of the field F1 by hand, while carrying the terminal apparatus 200. When the agricultural worker 70 is performing work in the field F1, if a notification of completion of a task is received from the agricultural machine 300 having finished its task for the field F2, for example, the processing unit 20 may decide not to allow the agricultural machine 300 to perform its agricultural task for the field F1, by referring to the table that associates agricultural tasks and priority levels. As a result, without being interfered by the agricultural machine 300, the agricultural worker 70 is able to continuously perform his or her agricultural task for the field F1. Based on the task schedule, the processing unit 20 may cause the agricultural machine 300 to move to another field distinct from the field F1, and allow it to perform the agricultural task in that field.

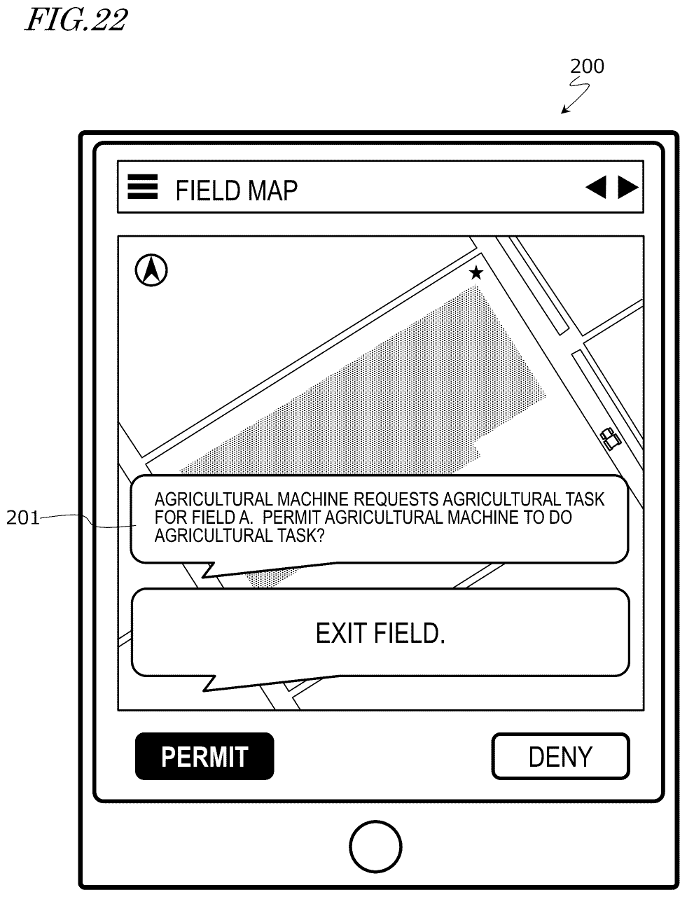

FIG. 21B is a diagram for describing, when the agricultural worker 70 is performing an agricultural task in the field F1, urging the agricultural worker 70 to exit the field F1 if a conflict of agricultural tasks exists with the agricultural machine 300. FIG. 22 is a diagram showing an example indication for notifying the terminal apparatus 200 that the agricultural machine 300 is trying to access the field F1.

By taking the task schedule shown in FIG. 20B for example, while the agricultural worker is performing manual work in the field F4, when the first agricultural machine 300A finishes its task for the field F1 and then is going to perform work in the field F4, a conflict of tasks may occur between the agricultural machine 300 and the agricultural worker 70.

When the agricultural worker 70 is performing an agricultural task in the field F1, if a notification of completion of a task is received from the agricultural machine 300 having finished its agricultural task for the field F2, for example, the processing unit 20 may notify the terminal apparatus 200 being used by the agricultural worker 70 that the agricultural machine 300 is trying to access the field F1. FIG. 22 shows a pop-up 201 being indicated on the display of the terminal apparatus 200. The agricultural worker 70 can be urged to exit the field F1 with such a notification. Upon receiving this notification, the agricultural worker 70 may exit the field F1 and concede the agricultural task for the field F1 to the agricultural machine 300, or deny the request from the agricultural machine and continue his or her agricultural task for the field F1. For example, if the task to be next performed by the agricultural machine 300 having been denied its request by the agricultural worker 70 has a high priority level, the processing unit 20 may cause the agricultural machine 300 to move to another field in accordance with the task schedule and allow it to perform its agricultural task.

Thus, by assigning a higher priority level to the agricultural worker 70 than to the agricultural machine 300, the aforementioned method of managing access to a field becomes applicable to cases where a conflict of tasks exists between the agricultural machine 300 and the agricultural worker 70. By relying on priority levels to permit the agricultural worker 70 a task with priority, it becomes possible to allow the agricultural worker 70 to continue his or her agricultural task without being interfered by the agricultural machine 300.

A method of managing access of a plurality of agricultural machines to a field or access to a field between an agricultural machine and an agricultural worker according to the present example embodiment may be implemented in a computer, by causing the computer to perform desired processes.

In the aforementioned example, under the management of access to a field by a processor of a server, a controller of the agricultural machine is configured or programmed to perform self-driving control to cause the agricultural machine to move to a field. Instead of this, however, the processor of the server may be configured or programmed to perform self-driving control to cause one or more agricultural machines to move to a field. In this case, self-driving of the agricultural machine (s) may be realized through remote manipulations at the server.

A system that provides various functions according to example embodiments can be mounted on an agricultural machine lacking such functions as an add-on. Such a system may be manufactured and sold independently from the agricultural machine. A computer program for use in such a system may also be manufactured and sold independently from the agricultural machine. The computer program may be provided in a form stored in a computer-readable, non-transitory storage medium, for example. The computer program may also be provided through downloading via telecommunication lines (e.g., the Internet).

The techniques according to examples of the present disclosure is applicable to agricultural machines, such as tractors, harvesters, rice transplanters, vehicles for crop management, vegetable transplanters, mowers, seeders, spreaders, or agricultural robots, for example.

While example embodiments of the present disclosure have been described above, it is to be understood that variations and modifications will be apparent to those skilled in the art without departing from the scope and spirit of the present invention. The scope of the present invention, therefore, is to be determined solely by the following claims.

What is claimed is:

1. A management system for managing access of a plurality of agricultural machines to a field, the management system comprising:
a processor configured or programmed to, while a first agricultural machine among the plurality of agricultural machines is performing an agricultural task in the field and if a conflict of agricultural tasks for the field exists between the first agricultural machine and a second agricultural machine among the plurality of agricultural machines, allow at least one of the first agricultural machine and the second agricultural machine determined based on priority data to perform the agricultural task for the field.

2. The management system of claim 1, further comprising a storage to store the priority data that includes information of a respective priority level assigned in accordance with a kind of agricultural task to be performed by each of the plurality of agricultural machines.

3. The management system of claim 1, wherein, when the priority level of the second agricultural machine is higher than the priority level of the first agricultural machine, the processor is configured or programmed to allow the second agricultural machine to perform the agricultural task for the field with priority over the first agricultural machine.

4. The management system of claim 3, wherein, when the priority level of the second agricultural machine is higher than the priority level of the first agricultural machine, the processor is configured or programmed to cause the first agricultural machine to stop the agricultural task for the field, and allow the second agricultural machine to perform the agricultural task for the field.

5. The management system of claim 4, wherein, when causing the first agricultural machine to stop the agricultural task for the field, the processor is configured or programmed to further cause the first agricultural machine to exit the field.

6. The management system of claim 2, wherein, when the priority level of the first agricultural machine and the priority level of the second agricultural machine are equal, the processor is configured or programmed to allow the first agricultural machine and the second agricultural machine to perform the agricultural tasks for the field.

7. The management system of claim 6, wherein, when the priority level of the first agricultural machine and the priority level of the second agricultural machine are equal, the processor is configured or programmed to allow the first agricultural machine to continue the agricultural task for the field, and further allows the second agricultural machine perform the agricultural task for the field.

8. The management system of claim 4, wherein, after the agricultural task by the second agricultural machine for another field distinct from the field is finished, in response to receiving a notification of completion of the agricultural task transmitted from the second agricultural machine, the processor is configured or programmed to allow the second agricultural machine to perform the agricultural task for the field.

9. The management system of claim 1, wherein, when a conflict of agricultural tasks for the field exists between the first agricultural machine, the second agricultural machine, and a third agricultural machine among the plurality of agricultural machines, the processor is configured or programmed to allow an agricultural machine to which a highest priority level is assigned among the first agricultural machine, the second agricultural machine, and the third agricultural machine to perform the agricultural task for the field.

10. The management system of claim 2, wherein
the priority data further includes information of a priority level assigned to an agricultural worker that is higher than the priority level of the second agricultural machine; and
while the agricultural worker is performing an agricultural task in the field, if the second agricultural machine is trying to access the field, the processor is configured or programmed to disallow the second agricultural machine to perform the agricultural task for the field, based on the priority data.

11. The management system of claim 2, wherein
the priority data further includes information of a priority level assigned to an agricultural worker that is higher than the priority level of the second agricultural machine; and
while the agricultural worker is performing an agricultural task in the field, if the second agricultural machine is trying to access the field, the processor is configured or programmed to notify a terminal apparatus being used by the agricultural worker that the second agricultural machine is trying to access the field.

12. The management system of claim 1, wherein the processor is configured or programmed to manage a schedule of agricultural tasks to be performed by each of the plurality of agricultural machines.

13. The management system of claim 12, wherein, when causing the first agricultural machine to exit the field while the first agricultural machine is performing an agricultural task in the field, the processor is configured or programmed to update the schedule of agricultural tasks to be performed by the first agricultural machine.

14. A management system for managing access to a field between an agricultural machine and an agricultural worker, the management system comprising:
a storage to store priority data including information of a priority level of the agricultural machine that is assigned to the agricultural machine and a priority level that is assigned to the agricultural worker and is higher than the priority level of the agricultural machine; and
a processor configured or programmed to, if a conflict of agricultural tasks for the field exists between the agricultural machine and the agricultural worker while the agricultural worker is performing the agricultural task in the field, allow the agricultural worker to continue the agricultural task for the field with priority over the agricultural machine, based on the priority data.

15. A computer-implemented method for managing access of a plurality of agricultural machines to a field, the method causing a computer to:
while a first agricultural machine among the plurality of agricultural machines is performing an agricultural task in the field, if a conflict of agricultural tasks for the field exists between the first agricultural machine and a second agricultural machine among the plurality of agricultural machines, allow at least one of the first agricultural machine and the second agricultural machine that is determined based on priority data to perform the agricultural task for the field.

16. A computer-implemented method for managing access to a field between an agricultural machine and an agricultural worker, the method causing a computer to:
read from a storage, priority data including information of a priority level of the agricultural machine that is assigned to the agricultural machine and a priority level that is assigned to the agricultural worker and is higher than the priority level of the agricultural machine; and
if a conflict of agricultural tasks for the field exists between the agricultural machine and the agricultural worker while the agricultural worker is performing the agricultural task in the field, allow the agricultural worker to continue the agricultural task for the field with priority over the agricultural machine, based on the priority data.
